(19) United States
(12) Patent Application Publication
(10) Pub. No.: US 2021/0055954 A1
(43) Pub. Date: Feb. 25, 2021

(54) SYSTEMS AND METHODS FOR POST CACHE INTERLOCKING

(71) Applicant: Dover Microsystems, Inc., Waltham, MA (US)

(72) Inventors: Steven Milburn, Cranston, RI (US); Nirmal Nepal, Needham, MA (US)

(73) Assignee: Dover Microsystems, Inc., Waltham, MA (US)

(21) Appl. No.: 16/966,865

(22) PCT Filed: Feb. 1, 2019
(86) PCT No.: PCT/US2019/016317

§ 371 Date: Jul. 31, 2020

Related U.S. Application Data
(60) Provisional application No. 62/625,770, filed on Feb. 2, 2018.
(60) Provisional application No. 62/635,475, filed on Feb. 26, 2018.

(51) Int. Cl. G06F 9/46; G06F 9/38; G06F 9/30; G06F 9/54

(52) U.S. Cl. CPC G06F 9/467; G06F 9/546; G06F 9/30043; G06F 9/3836

(57) ABSTRACT

Systems and methods for a write interlock configured to perform first processing and second processing, decoupled from the first processing. In some aspects, the first processing comprises receiving, from a processor, a store instruction including a target address, storing, in a data structure, a first entry corresponding to the store instruction, initiating a check of the store instruction against at least one policy, and in response to successful completion of the check, removing the first entry from the data structure. The second processing comprises receiving, from the processor, a write transaction including a target address, determining whether any entry in the data structure relates to the target address of the write transaction, and in response to determining that no entry in the data structure relates to the target address of the write transaction, causing the data to be written to the target address of the write transaction.

### RELATED APPLICATIONS

This application claims the benefit under 35 U.S.C. § 119(e) of U.S. Provisional Patent Application Ser. No. 62/625,770, filed on Feb. 2, 2018, titled “SYSTEMS AND METHODS FOR POST CACHE INTERLOCKING,” bearing Attorney Docket No. D0821.70003US00, and U.S. Provisional Patent Application Ser. No. 62/635,475, filed on Feb. 26, 2018, titled “SYSTEMS AND METHODS FOR POST CACHE INTERLOCKING,” bearing Attorney Docket No. D0821.70003US01, each of which is hereby incorporated by reference in its entirety.

This application is being filed on the same day as:
International Patent Application No. ______, titled “SYSTEMS AND METHODS FOR SECURE INITIALIZATION,” bearing Attorney Docket No. D0821.70000WO00, claiming the benefit under 35 U.S.C. § 119(e) of U.S. Provisional Patent Application Ser. No. 62/625,822, filed on Feb. 2, 2018, titled “SYSTEMS AND METHODS FOR SECURE INITIALIZATION,” bearing Attorney Docket No. D0821.70000US00, and U.S. Provisional Patent Application Ser. No. 62/635,289, filed on Feb. 26, 2018, titled “SYSTEMS AND METHODS FOR SECURE INITIALIZATION,” bearing Attorney Docket No. D0821.70000US01; and
International Patent Application No. ______, titled “SYSTEMS AND METHODS FOR TRANSFORMING INSTRUCTIONS FOR METADATA PROCESSING,” bearing Attorney Docket No. D0821.70001WO00, claiming the benefit under 35 U.S.C. § 119(e) of U.S. Provisional Patent Application Ser. No. 62/625,746, filed on Feb. 2, 2018, titled “SYSTEMS AND METHODS FOR TRANSLATING BETWEEN INSTRUCTION SET ARCHITECTURES,” bearing Attorney Docket No. D0821.70001US00, U.S. Provisional Patent Application Ser. No. 62/635,319, filed on Feb. 26, 2018, titled “SYSTEMS AND METHODS FOR TRANSFORMING INSTRUCTIONS FOR METADATA PROCESSING,” bearing Attorney Docket No. D0821.70001US01, and U.S. Provisional Patent Application Ser. No. 62/625,802, filed on Feb. 2, 2018, titled “SYSTEMS AND METHODS FOR SECURING INTERRUPT SERVICE ROUTINE ENTRY,” bearing Attorney Docket No. D0821.70004US00.

Each of the above-referenced applications is hereby incorporated by reference in its entirety.

### BACKGROUND

Computer security has become an increasingly urgent concern at all levels of society, from individuals to businesses to government institutions. For example, in 2015, security researchers identified a zero-day vulnerability that would have allowed an attacker to hack into a Jeep Cherokee's on-board computer system via the Internet and take control of the vehicle's dashboard functions, steering, brakes, and transmission. In 2017, the WannaCry ransomware attack was estimated to have affected more than 200,000 computers worldwide, causing at least hundreds of millions of dollars in economic losses. Notably, the attack crippled operations at several National Health Service hospitals in the UK. In the same year, a data breach at Equifax, a US consumer credit reporting agency, exposed person data such as full names, social security numbers, birth dates, addresses, driver's license numbers, credit card numbers, etc. That attack is reported to have affected over 140 million consumers.

Security professionals are constantly playing catch-up with attackers. As soon as a vulnerability is reported, security professionals race to patch the vulnerability. Individuals and organizations that fail to patch vulnerabilities in a timely manner (e.g., due to poor governance and/or lack of resources) become easy targets for attackers.

Some security software monitors activities on a computer and/or within a network, and looks for patterns that may be indicative of an attack. Such an approach does not prevent malicious code from being executed in the first place. Often, the damage has been done by the time any suspicious pattern emerges.

### SUMMARY

In some aspects, the systems and methods described herein provide for a method for execution by a write interlock, comprising acts of performing first processing and second processing, decoupled from the first processing. The first processing comprises receiving, from a processor, a store instruction including a target address. The first processing further comprises storing, in a data structure, a first entry corresponding to the store instruction, wherein the first entry includes information relating to the target address of the store instruction. The first processing further comprises initiating a check of the store instruction against at least one policy. The first processing further comprises, in response to successful completion of the check, removing the first entry from the data structure. The second processing comprises receiving, from the processor, a write transaction including a target address to which data is to be written. The second processing further comprises, in response to receiving the write transaction, determining whether any entry in the data structure relates to the target address of the write transaction. The second processing further comprises, in response to determining that no entry in the data structure relates to the target address of the write transaction, causing the data to be written to the target address of the write transaction.

In some embodiments, the second processing further comprises causing the write transaction to be stalled. In some embodiments, the write transaction is stalled for a period of time. The period of time is selected based on an estimated amount of time between the processor executing the store instruction and the store instruction being stored by the write interlock in the data structure in the first processing. In some embodiments, the write transaction is stalled until a selected number of instructions has been received from the processor in the first processing.

In some embodiments, the method further comprises an act of storing, to an address range accessible by violation processing code to be executed by the processor, a snapshot of the data structure at a time of a policy violation. The method further comprises an act of triggering an interrupt to the processor to initiate execution of the violation processing code. In some embodiments, the interrupt causes the processor to invalidate at least one data cache line from a data cache that includes at least one address that was in the data structure at the time of the policy violation.

In some embodiments, the method further comprises an act of storing, to an address range accessible by violation processing code to be executed by the processor, a snapshot of the data structure at a time of a policy violation. The method further comprises an act of triggering an interrupt to the processor to initiate execution of the violation processing code, to cause eviction, from a data cache, of at least one data cache line that includes at least one address that was in the data structure at the time of the policy violation. The method further comprises an act of entering a violation handling mode where future writes to main memory attempted by the processor are acknowledged to the processor but are discarded and not sent to the main memory. The method further comprises an act of, in response to an indication that the processor has completed violation processing, exiting the violation handling mode.

In some embodiments, the indication comprises a signal received from the processor indicating that the processor has completed violation processing. In some embodiments, the indication comprises a determination that all data cache lines including at least one address that was in the data structure at the time of the policy violation have been evicted.

In some embodiments, the write transaction from the processor comprises a first write transaction, and is received by the write interlock on a first interface. In response to determining that no entry in the data structure relates to the target address of the write transaction, the data is written to the target address of the write transaction via a second write transaction on a second interface.

In some embodiments, the write transaction from the processor comprises a first write transaction, and is received by the write interlock on a first interface. The second processing further comprises an act of storing the first write transaction in a write queue. The second processing further comprises an act of acknowledging the first write transaction to the processor. In response to determining that no entry in the data structure relates to the target address of the write transaction, the data is written to the target address of the write transaction via a second write transaction on a second interface.

In some embodiments, the second processing further comprises an act of determining whether the target address of the write transaction is cached. The first write transaction is stored in the write queue in response to determining that the target address of the write transaction is not cached.

In some embodiments, the data written by the second write transaction is retrieved from an entry in the write queue storing the first write transaction. In some embodiments, the second processing further comprises an act of, after retrieving the data for the second write transaction, removing, from the write queue, the entry storing the first write transaction.

In some embodiments, the write interlock acknowledges the write transaction to the processor, but discards the data of the write transaction.

In some embodiments, the write transaction from the processor comprises a first write transaction, and is received by the write interlock on a first interface. The second processing further comprises an act of determining whether the target address of the write transaction is cached. The second processing further comprises an act of, in response to determining that the target address of the write transaction is cached, causing the first write transaction to be stalled until it is determined that no entry in the data structure relates to the target address of the write transaction. In response to determining that no entry in the data structure relates to the target address of the write transaction, the data is written to the target address of the write transaction via a second write transaction on a second interface.

In some embodiments, determining whether the target address of the write transaction is cached comprises determining whether the target address of the write transaction is included in an address range for non-cached addresses. In some embodiments, determining whether the target address of the write transaction is cached comprises determining whether a signal from a data cache indicates the target address of the write transaction as cached.

In some embodiments, a first destructive read instruction is performed, a second destructive read instruction attempting to access a target address of the first destructive read instruction is stalled, and, in response to successful completion of a check of the first destructive read instruction, the second destructive read instruction is allowed to proceed.

In some embodiments, a destructive read instruction is executed and data read from a target address of the destructive read instruction is captured in a buffer and, in response to successful completion of a check of the destructive read instruction, the data captured in the buffer is discarded. In some embodiments, in response to unsuccessful completion of the check of the destructive read instruction, the data captured in the buffer is restored to the target address. In some embodiments, in response to unsuccessful completion of the check of the destructive read instruction, a subsequent instruction attempting to access the target address of the destructive read instruction is provided the data captured in the buffer.

In some aspects, the systems and methods described herein provide for a method for execution by a write interlock comprising an act of receiving, from a processor, a store instruction including a target address to which data is to be stored, wherein the target address is not cached. The method further comprises an act of storing the data in a write queue associated with the write interlock. The method further comprises an act of initiating a check of the store instruction against at least one policy. The method further comprises an act of, in response to successful completion of the check, causing a write transaction to write the data to the target address.

In some embodiments, the method further comprises an act of determining whether the target address is cached, wherein the data is stored in the write queue in response to determining that the target address is not cached.

In some aspects, the systems and methods described herein provide for a method for execution by a write interlock comprising acts of performing first processing and second processing, decoupled from the first processing. The first processing comprises receiving, from a processor, a store instruction including a target address and data to be stored to the target address of the store instruction. The first processing further comprises storing, in a data structure, a first entry corresponding to the store instruction, wherein the first entry includes the target address of the store instruction and the data. The first processing further comprises initiating a check of the store instruction against at least one policy. The first processing further comprises, in response to successful completion of the check, removing the first entry from the data structure and storing the data in a cache associated with the write interlock. The second processing comprises receiving, from the processor, a read transaction including a target address from which data is to be read. The second processing further comprises determining whether any entry in the data structure relates to the target address of the read transaction received from the processor. The second processing further comprises, in response to determining that no entry in the data structure relates to the target address of the read transaction, causing the read transaction to access data in the cache associated with the write interlock.

In some embodiments, the read transaction is stalled until no entry in the data structure relates to the target address of the read transaction.

In some embodiments, in response to determining that at least one entry in the data structure relates to the target address of the read transaction, causing the read transaction to access data from a most recent entry of the data structure related to the target address of the read transaction.

In some embodiments, a data cache of the processor evicts a data cache line without performing a write transaction, independent of a state of a dirty bit for the data cache line.

In some embodiments, the write interlock acknowledges a write transaction from the data cache of the processor, but discards data relating to the write transaction.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

### BRIEF DESCRIPTION OF DRAWINGS

Various non-limiting embodiments of the technology will be described with reference to the following figures. It should be appreciated that the figures are not necessarily drawn to scale.

FIG. 1 shows an illustrative hardware system 100 for enforcing policies, in accordance with some embodiments.

FIG. 2 shows an illustrative software system 200 for enforcing policies, in accordance with some embodiments.

FIG. 3 shows an illustrative hardware system 300 for enforcing policies, in accordance with some embodiments.

FIG. 4 shows an illustrative block diagram 400 for enforcing policies, in accordance with some embodiments.

FIG. 5 shows an illustrative hardware system 500 for enforcing policies, in accordance with some embodiments.

FIG. 6 shows an illustrative block diagram 600 for enforcing policies, in accordance with some embodiments.

FIG. 7 shows an illustrative scorecard 700, in accordance with some embodiments.

FIG. 8 shows illustrative flow diagrams 800 and 850 for enforcing policies, in accordance with some embodiments.

FIG. 9 shows an illustrative flow diagram 900 for handling a policy violation, in accordance with some embodiments.

FIG. 10 shows an illustrative flow diagram 1000 for handling a policy violation, in accordance with some embodiments.

FIG. 11 shows an illustrative flow diagram 1100 for enforcing policies, in accordance with some embodiments.

FIG. 12 shows illustrative flow diagrams 1200 and 1250 for enforcing policies, in accordance with some embodiments.

FIG. 13 shows, schematically, an illustrative computer 1300 on which any aspect of the present disclosure may be implemented.

### DETAILED DESCRIPTION

Many vulnerabilities exploited by attackers trace back to a computer architectural design where data and executable instructions are intermingled in a same memory. This intermingling allows an attacker to inject malicious code into a remote computer by disguising the malicious code as data. For instance, a program may allocate a buffer in a computer's memory to store data received via a network. If the program receives more data than the buffer can hold, but does not check the size of the received data prior to writing the data into the buffer, part of the received data would be written beyond the buffer's boundary, into adjacent memory. An attacker may exploit this behavior to inject malicious code into the adjacent memory. If the adjacent memory is allocated for executable code, the malicious code may eventually be executed by the computer.

Techniques have been proposed to make computer hardware more security aware. For instance, memory locations may be associated with metadata for use in enforcing security policies, and instructions may be checked for compliance with the security policies. For example, given an instruction to be executed, metadata associated with the instruction and/or metadata associated with one or more operands of the instruction may be checked to determine if the instruction should be allowed. Additionally, or alternatively, appropriate metadata may be associated with an output of the instruction.

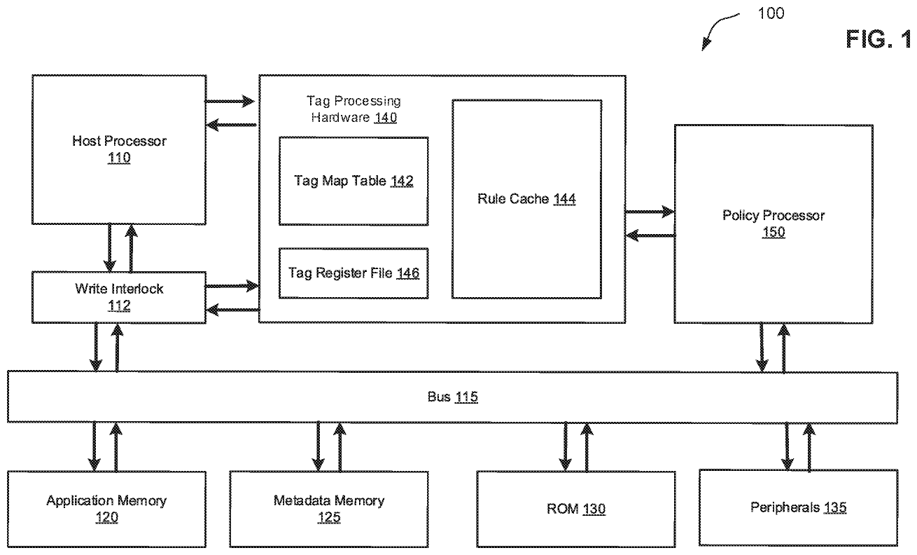

FIG. 1 shows an illustrative hardware system 100 for enforcing policies, in accordance with some embodiments. In this example, the system 100 includes a host processor 110, which may have any suitable instruction set architecture (ISA) such as a reduced instruction set computing (RISC) architecture or a complex instruction set computing (CISC) architecture. The host processor 110 may perform memory accesses via a write interlock 112. The write interlock 112 may be connected to a system bus 115 configured to transfer data between various components such as the write interlock 112, an application memory 120, a metadata memory 125, a read-only memory (ROM) 130, one or more peripherals 135, etc.

In some embodiments, data that is manipulated (e.g., modified, consumed, and/or produced) by the host processor 110 may be stored in the application memory 120. Such data is referred to herein as “application data,” as distinguished from metadata used for enforcing policies. The latter may be stored in the metadata memory 125. It should be appreciated that application data may include data manipulated by an operating system (OS), instructions of the OS, data manipulated by one or more user applications, and/or instructions of the one or more user applications.

In some embodiments, the application memory 120 and the metadata memory 125 may be physically separate, and the host processor 110 may have no access to the metadata memory 125. In this manner, even if an attacker succeeds in injecting malicious code into the application memory 120 and causing the host processor 110 to execute the malicious code, the metadata memory 125 may not be affected. However, it should be appreciated that aspects of the present disclosure are not limited to storing application data and metadata on physically separate memories. Additionally, or alternatively, metadata may be stored in a same memory as application data, and a memory management component may be used that implements an appropriate protection scheme to prevent instructions executing on the host processor 110 from modifying the metadata. Additionally, or alternatively, metadata may be intermingled with application data in a same memory, and one or more policies may be used to protect the metadata.

In some embodiments, tag processing hardware 140 may be provided to ensure that instructions being executed by the host processor 110 comply with one or more policies. The tag processing hardware 140 may include any suitable circuit component or combination of circuit components. For instance, the tag processing hardware 140 may include a tag map table 142 that maps addresses in the application memory 120 to addresses in the metadata memory 125. For example, the tag map table 142 may map address X in the application memory 120 to address Y in the metadata memory 125. Such an address Y is referred to herein as a “metadata tag” or simply a “tag.” A value stored at the address Y is also referred to herein as a “metadata tag” or simply a “tag.”

In some embodiments, a value stored at the address Y may in turn be an address Z. Such indirection may be repeated any suitable number of times, and may eventually lead to a data structure in the metadata memory 125 for storing metadata. Such metadata, as well as any intermediate address (e.g., the address Z), are also referred to herein as “metadata tags” or simply “tags.”

It should be appreciated that aspects of the present disclosure are not limited to a tag map table that stores addresses in a metadata memory. In some embodiments, a tag map table entry itself may store metadata, so that the tag processing hardware 140 may be able to access the metadata without performing a memory operation. In some embodiments, a tag map table entry may store a selected bit pattern, where a first portion of the bit pattern may encode metadata, and a second portion of the bit pattern may encode an address in a metadata memory where further metadata may be stored. This may provide a desired balance between speed and expressivity. For instance, the tag processing hardware 140 may be able to check certain policies quickly, using only the metadata stored in the tag map table entry itself. For other policies with more complex rules, the tag processing hardware 140 may access the further metadata stored in the metadata memory 125.

Referring again to FIG. 1, by mapping application memory addresses to metadata memory addresses, the tag map table 142 may create an association between application data and metadata that describes the application data. In one example, metadata stored at the metadata memory address Y and thus associated with application data stored at the application memory address X may indicate that the application data may be readable, writable, and/or executable. In another example, metadata stored at the metadata memory address Y and thus associated with application data stored at the application memory address X may indicate a type of the application data (e.g., integer, pointer, 16-bit word, 32-bit word, etc.). Depending on a policy to be enforced, any suitable metadata relevant for the policy may be associated with a piece of application data.

In some embodiments, a metadata memory address Z may be stored at the metadata memory address Y. Metadata to be associated with the application data stored at the application memory address X may be stored at the metadata memory address Z, instead of (or in addition to) the metadata memory address Y. For instance, a binary representation of a metadata symbol “RED” may be stored at the metadata memory address Z. By storing the metadata memory address Z in the metadata memory address Y, the application data stored at the application memory address X may be tagged “RED.”

In this manner, the binary representation of the metadata symbol “RED” may be stored only once in the metadata memory 120. For instance, if application data stored at another application memory address X′ is also to be tagged “RED,” the tag map table 142 may map the application memory address X′ to a metadata memory address Y′ where the metadata memory address Z is also stored.

Moreover, in this manner, tag update may be simplified. For instance, if the application data stored at the application memory address X is to be tagged “BLUE” at a subsequent time, a metadata memory address Z′ may be written at the metadata memory address Y, to replace the metadata memory address Z, and a binary representation of the metadata symbol “BLUE” may be stored at the metadata memory address Z′.

Thus, the inventors have recognized and appreciated that a chain of metadata memory addresses of any suitable length N may be used for tagging, including N=0 (e.g., where a binary representation of a metadata symbol is stored at the metadata memory address Y itself).

The association between application data and metadata (also referred to herein as “tagging”) may be done at any suitable level of granularity, and/or variable granularity. For instance, tagging may be done on a word-by-word basis. Additionally, or alternatively, a region in memory may be mapped to a single tag, so that all words in that region are associated with the same metadata. This may advantageously reduce a size of the tag map table 142 and/or the metadata memory 125. For example, a single tag may be maintained for an entire address range, as opposed to maintaining multiple tags corresponding, respectively, to different addresses in the address range.

In some embodiments, the tag processing hardware 140 may be configured to apply one or more security rules to metadata associated with an instruction and/or metadata associated with one or more operands of the instruction to determine if the instruction should be allowed. For instance, the host processor 110 may fetch and execute an instruction, and may queue a result of executing the instruction into the write interlock 112. Before the result is written back into the application memory 120, the host processor 110 may send, to the tag processing hardware 140, an instruction type (e.g., opcode), an address where the instruction is stored, one or more memory addresses referenced by the instruction, and/or one or more register identifiers. Such a register identifier may identify a register used by the host processor 110 in executing the instruction, such as a register for storing an operand or a result of the instruction.

In some embodiments, destructive read instructions may be queued in addition to, or instead of, write instructions. For instance, subsequent instructions attempting to access a target address of a destructive read instruction may be queued in a memory region that is not cached. If and when it is determined that the destructive read instruction should be allowed, the queued instructions may be loaded for execution.

In some embodiments, a first destructive read instruction may be performed. The tag processing hardware 140 may determine whether the first destructive read instruction should be allowed. If a second destructive read instruction attempts to access a target address of the first destructive read instruction, the second destructive read instruction may be stalled until it is determined that the first destructive read instruction should be allowed. If and when it is determined that the first destructive read instruction should be allowed, the second destructive read instruction is un-stalled and may be allowed to proceed.

In some embodiments, a destructive read instruction may be allowed to proceed, and data read from a target address may be captured in a buffer. If and when it is determined that the destructed read instruction should be allowed, the data captured in the buffer may be discarded. If and when it is determined that the destructive read instruction should not be allowed, the data captured in the buffer may be restored to the target address. Additionally, or alternatively, a subsequent read may be serviced by the buffered data.

It should be appreciated that aspects of the present disclosure are not limited to performing metadata processing on instructions that have been executed by a host processor, such as instructions that have been retired by the host processor's execution pipeline. In some embodiments, metadata processing may be performed on instructions before, during, and/or after the host processor's execution pipeline.

In some embodiments, given an address received from the host processor 110 (e.g., an address where an instruction is stored, or an address referenced by an instruction), the tag processing hardware 140 may use the tag map table 142 to identify a corresponding tag. Additionally, or alternatively, for a register identifier received from the host processor 110, the tag processing hardware 140 may access a tag from a tag register file 146 within the tag processing hardware 140.

In some embodiments, if an application memory address does not have a corresponding tag in the tag map table 142, the tag processing hardware 140 may send a query to a policy processor 150. The query may include the application memory address in question, and the policy processor 150 may return a tag for that application memory address. Additionally, or alternatively, the policy processor 150 may create a new tag map entry for an address range including the application memory address. In this manner, the appropriate tag may be made available, for future reference, in the tag map table 142 in association with the application memory address in question.

In some embodiments, the tag processing hardware 140 may send a query to the policy processor 150 to check if an instruction executed by the host processor 110 should be allowed. The query may include one or more inputs, such as an instruction type (e.g., opcode) of the instruction, a tag for a program counter, a tag for an application memory address from which the instruction is fetched (e.g., a word in memory to which the program counter points), a tag for a register in which an operand of the instruction is stored, and/or a tag for an application memory address referenced by the instruction. In one example, the instruction may be a load instruction, and an operand of the instruction may be an application memory address from which application data is to be loaded. The query may include, among other things, a tag for a register in which the application memory address is stored, as well as a tag for the application memory address itself. In another example, the instruction may be an arithmetic instruction, and there may be two operands. The query may include, among other things, a first tag for a first register in which a first operand is stored, and a second tag for a second register in which a second operand is stored.

It should also be appreciated that aspects of the present disclosure are not limited to performing metadata processing on a single instruction at a time. In some embodiments, multiple instructions in a host processor's ISA may be checked together as a bundle, for example, via a single query to the policy processor 150. Such a query may include more inputs to allow the policy processor 150 to check all of the instructions in the bundle. Similarly, a CISC instruction, which may correspond semantically to multiple operations, may be checked via a single query to the policy processor 150, where the query may include sufficient inputs to allow the policy processor 150 to check all of the constituent operations within the CISC instruction.

In some embodiments, the policy processor 150 may include a configurable processing unit, such as a microprocessor, a field-programmable gate array (FPGA), and/or any other suitable circuitry. The policy processor 150 may have loaded therein one or more policies that describe allowed operations of the host processor 110. In response to a query from the tag processing hardware 140, the policy processor 150 may evaluate one or more of the policies to determine if an instruction in question should be allowed. For instance, the tag processing hardware 140 may send an interrupt signal to the policy processor 150, along with one or more inputs relating to the instruction in question (e.g., as described above). The policy processor 150 may store the inputs of the query in a working memory (e.g., in one or more queues) for immediate or deferred processing. For example, the policy processor 150 may prioritize processing of queries in some suitable manner (e.g., based on a priority flag associated with each query).

In some embodiments, the policy processor 150 may evaluate one or more policies on one or more inputs (e.g., one or more input tags) to determine if an instruction in question should be allowed. If the instruction is not to be allowed, the policy processor 150 may so notify the tag processing hardware 140. If the instruction is to be allowed, the policy processor 150 may compute one or more outputs (e.g., one or more output tags) to be returned to the tag processing hardware 140. As one example, the instruction may be a store instruction, and the policy processor 150 may compute an output tag for an application memory address to which application data is to be stored. As another example, the instruction may be an arithmetic instruction, and the policy processor 150 may compute an output tag for a register for storing a result of executing the arithmetic instruction.

In some embodiments, the policy processor 150 may be programmed to perform one or more tasks in addition to, or instead of, those relating to evaluation of policies. For instance, the policy processor 150 may perform tasks relating to tag initialization, boot loading, application loading, memory management (e.g., garbage collection) for the metadata memory 125, logging, debugging support, and/or interrupt processing. One or more of these tasks may be performed in the background (e.g., between servicing queries from the tag processing hardware 140).

In some embodiments, the tag processing hardware 140 may include a rule cache 144 for mapping one or more input tags to a decision and/or one or more output tags. For instance, a query into the rule cache 144 may be similarly constructed as a query to the policy processor 150 to check if an instruction executed by the host processor 110 should be allowed. If there is a cache hit, the rule cache 144 may output a decision as to whether to the instruction should be allowed, and/or one or more output tags (e.g., as described above in connection with the policy processor 150). Such a mapping in the rule cache 144 may be created using a query response from the policy processor 150. However, that is not required, as in some embodiments, one or more mappings may be installed into the rule cache 144 ahead of time.

In some embodiments, the rule cache 144 may be used to provide a performance enhancement. For instance, before querying the policy processor 150 with one or more input tags, the tag processing hardware 140 may first query the rule cache 144 with the one or more input tags. In case of a cache hit, the tag processing hardware 140 may proceed with a decision and/or one or more output tags from the rule cache 144, without querying the policy processor 150. This may provide a significant speedup. In case of a cache miss, the tag processing hardware 140 may query the policy processor 150 and install a response from the policy processor 150 into the rule cache 144 for potential future use.

In some embodiments, if the tag processing hardware 140 determines that an instruction in question should be allowed (e.g., based on a hit in the rule cache 144, or a miss in the rule cache 144, followed by a response from the policy processor 150 indicating no policy violation has been found), the tag processing hardware 140 may indicate to the write interlock 112 that a result of executing the instruction may be written back to memory. Additionally, or alternatively, the tag processing hardware 140 may update the metadata memory 125, the tag map table 142, and/or the tag register file 146 with one or more output tags (e.g., as received from the rule cache 144 or the policy processor 150). As one example, for a store instruction, the metadata memory 125 may be updated via an address translation by the tag map table 142. For instance, an application memory address referenced by the store instruction may be used to look up a metadata memory address from the tag map table 142, and metadata received from the rule cache 144 or the policy processor 150 may be stored to the metadata memory 125 at the metadata memory address. As another example, where metadata to be updated is stored in an entry in the tag map table 142 (as opposed to being stored in the metadata memory 125), that entry in the tag map table 142 may be updated. As another example, for an arithmetic instruction, an entry in the tag register file 146 corresponding to a register used by the host processor 110 for storing a result of executing the arithmetic instruction may be updated with an appropriate tag.

In some embodiments, if the tag processing hardware 140 determines that the instruction in question represents a policy violation (e.g., based on a miss in the rule cache 144, followed by a response from the policy processor 150 indicating a policy violation has been found), the tag processing hardware 140 may indicate to the write interlock 112 that a result of executing the instruction should be discarded, instead of being written back to memory. Additionally, or alternatively, the tag processing hardware 140 may send an interrupt to the host processor 110. In response to receiving the interrupt, the host processor 110 may switch to any suitable violation processing code. For example, the host processor 100 may halt, reset, log the violation and continue, perform an integrity check on application code and/or application data, notify an operator, etc.

In some embodiments, the tag processing hardware 140 may include one or more configuration registers. Such a register may be accessible (e.g., by the policy processor 150) via a configuration interface of the tag processing hardware 140. In some embodiments, the tag register file 146 may be implemented as configuration registers. Additionally, or alternatively, there may be one or more application configuration registers and/or one or more metadata configuration registers.

Although details of implementation are shown in FIG. 1 and discussed above, it should be appreciated that aspects of the present disclosure are not limited to the use of any particular component, or combination of components, or to any particular arrangement of components. For instance, in some embodiments, one or more functionalities of the policy processor 150 may be performed by the host processor 110. As an example, the host processor 110 may have different operating modes, such as a user mode for user applications and a privileged mode for an operating system. Policy-related code (e.g., tagging, evaluating policies, etc.) may run in the same privileged mode as the operating system, or a different privileged mode (e.g., with even more protection against privilege escalation).

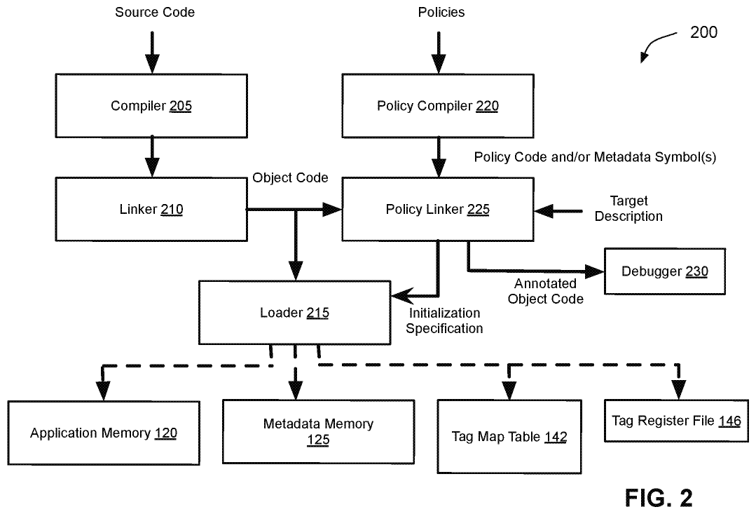

FIG. 2 shows an illustrative software system 200 for enforcing policies, in accordance with some embodiments. For instance, the software system 200 may be programmed to generate executable code and/or load the executable code into the illustrative hardware system 100 shown in FIG. 1.

In the example shown in FIG. 2, the software system 200 includes a software toolchain having a compiler 205, a linker 210, and a loader 215. The compiler 205 may be programmed to process source code into executable code, where the source code may be in a higher-level language and the executable code may be in a lower level language. The linker 210 may be programmed to combine multiple object files generated by the compiler 205 into a single object file to be loaded by the loader 215 into memory (e.g., the illustrative application memory 120 in the example of FIG. 1). Although not shown, the object file output by the linker 210 may be converted into a suitable format and stored in persistent storage, such as flash memory, hard disk, read-only memory (ROM), etc. The loader 215 may retrieve the object file from the persistent storage, and load the object file into random-access memory (RAM).

In some embodiments, the compiler 205 may be programmed to generate information for use in enforcing policies. For instance, as the compiler 205 translates source code into executable code, the compiler 205 may generate information regarding data types, program semantics and/or memory layout. As one example, the compiler 205 may be programmed to mark a boundary between one or more instructions of a function and one or more instructions that implement calling convention operations (e.g., passing one or more parameters from a caller function to a callee function, returning one or more values from the callee function to the caller function, storing a return address to indicate where execution is to resume in the caller function's code when the callee function returns control back to the caller function, etc.). Such boundaries may be used, for instance, during initialization to tag certain instructions as function prologue or function epilogue. At run time, a stack policy may be enforced so that, as function prologue instructions execute, certain locations in a call stack (e.g., where a return address is stored) may be tagged as “frame” locations, and as function epilogue instructions execute, the “frame” tags may be removed. The stack policy may indicate that instructions implementing a body of the function (as opposed to function prologue and function epilogue) only have read access to “frame” locations. This may prevent an attacker from overwriting a return address and thereby gaining control.

As another example, the compiler 205 may be programmed to perform control flow analysis, for instance, to identify one or more control transfer points and respective destinations. Such information may be used in enforcing a control flow policy. As yet another example, the compiler 205 may be programmed to perform type analysis, for example, by applying type labels such as Pointer, Integer, Floating-Point Number, etc. Such information may be used to enforce a policy that prevents misuse (e.g., using a floating-point number as a pointer).

Although not shown in FIG. 2, the software system 200 may, in some embodiments, include a binary analysis component programmed to take, as input, object code produced by the linker 210 (as opposed to source code), and perform one or more analyses similar to those performed by the compiler 205 (e.g., control flow analysis, type analysis, etc.).

In the example of FIG. 2, the software system 200 further includes a policy compiler 220 and a policy linker 225. The policy compiler 220 may be programmed to translate a policy written in a policy language into policy code. For instance, the policy compiler 220 may output policy code in C or some other suitable programming language. Additionally, or alternatively, the policy compiler 220 may output one or more metadata symbols referenced by the policy. At initialization, such a metadata symbol may be associated with one or more memory locations, registers, and/or other machine state of a target system, and may be resolved into a binary representation of metadata to be loaded into a metadata memory or some other hardware storage (e.g., registers) of the target system. As discussed above, such a binary representation of metadata, or a pointer to a location at which the binary representation is stored, is sometimes referred to herein as a “tag.”

It should be appreciated that aspects of the present disclosure are not limited to resolving metadata symbols at load time. In some embodiments, one or more metadata symbols may be resolved statically (e.g., at compile time or link time). For example, the policy compiler 220 may process one or more applicable policies, and resolve one or more metadata symbols defined by the one or more policies into a statically-defined binary representation. Additionally, or alternatively, the policy linker 225 may resolve one or more metadata symbols into a statically-defined binary representation, or a pointer to a data structure storing a statically-defined binary representation. The inventors have recognized and appreciated that resolving metadata symbols statically may advantageously reduce load time processing. However, aspects of the present disclosure are not limited to resolving metadata symbols in any particular manner.

In some embodiments, the policy linker 225 may be programmed to process object code (e.g., as output by the linker 210), policy code (e.g., as output by the policy compiler 220), and/or a target description, to output an initialization specification. The initialization specification may be used by the loader 215 to securely initialize a target system having one or more hardware components (e.g., the illustrative hardware system 100 shown in FIG. 1) and/or one or more software components (e.g., an operating system, one or more user applications, etc.).

In some embodiments, the target description may include descriptions of a plurality of named entities. A named entity may represent a component of a target system. As one example, a named entity may represent a hardware component, such as a configuration register, a program counter, a register file, a timer, a status flag, a memory transfer unit, an input/output device, etc. As another example, a named entity may represent a software component, such as a function, a module, a driver, a service routine, etc.

In some embodiments, the policy linker 225 may be programmed to search the target description to identify one or more entities to which a policy pertains. For instance, the policy may map certain entity names to corresponding metadata symbols, and the policy linker 225 may search the target description to identify entities having those entity names. The policy linker 225 may identify descriptions of those entities from the target description, and use the descriptions to annotate, with appropriate metadata symbols, the object code output by the linker 210. For instance, the policy linker 225 may apply a Read label to a .rodata section of an Executable and Linkable Format (ELF) file, a Read label and a Write label to a .data section of the ELF file, and an Execute label to a .text section of the ELF file. Such information may be used to enforce a policy for memory access control and/or executable code protection (e.g., by checking read, write, and/or execute privileges).

It should be appreciated that aspects of the present disclosure are not limited to providing a target description to the policy linker 225. In some embodiments, a target description may be provided to the policy compiler 220, in addition to, or instead of, the policy linker 225. The policy compiler 220 may check the target description for errors. For instance, if an entity referenced in a policy does not exist in the target description, an error may be flagged by the policy compiler 220. Additionally, or alternatively, the policy compiler 220 may search the target description for entities that are relevant for one or more policies to be enforced, and may produce a filtered target description that includes entities descriptions for the relevant entities only. For instance, the policy compiler 220 may match an entity name in an “init” statement of a policy to be enforced to an entity description in the target description, and may remove from the target description entity descriptions with no corresponding “init” statement.

In some embodiments, the loader 215 may initialize a target system based on an initialization specification produced by the policy linker 225. For instance, with reference to the example of FIG. 1, the loader 215 may load data and/or instructions into the application memory 120, and may use the initialization specification to identify metadata labels associated with the data and/or instructions being loaded into the application memory 120. The loader 215 may resolve the metadata labels in the initialization specification into respective binary representations. However, it should be appreciated that aspects of the present disclosure are not limited to resolving metadata labels at load time. In some embodiments, a universe of metadata labels may be known during policy linking, and therefore metadata labels may be resolved at that time, for example, by the policy linker 225. This may advantageously reduce load time processing of the initialization specification.

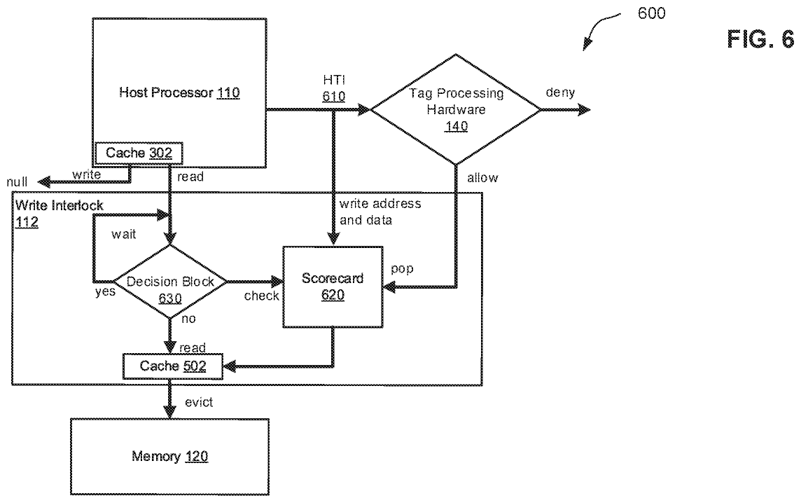

In some embodiments, the policy linker 225 and/or the loader 215 may maintain a mapping of binary representations of metadata back to metadata labels. Such a mapping may be used, for example, by a debugger 230. For instance, in some embodiments, the debugger 230 may be provided to display a human readable version of an initialization specification, which may list one or more entities and, for each entity, a set of one or more metadata labels associated with the entity. Additionally, or alternatively, the debugger 230 may be programmed to display assembly code annotated with metadata labels, such as assembly code generated by disassembling object code annotated with metadata labels. An example of such assembly code is shown in FIG. 6 and discussed below. During debugging, the debugger 230 may halt a program during execution, and allow inspection of entities and/or metadata tags associated with the entities, in human readable form. For instance, the debugger 230 may allow inspection of entities involved in a policy violation and/or metadata tags that caused the policy violation. The debugger 230 may do so using the mapping of binary representations of metadata back to metadata labels.

In some embodiments, a conventional debugging tool may be extended allow review of issues related to policy enforcement, for example, as described above. Additionally, or alternatively, a stand-alone policy debugging tool may be provided.

In some embodiments, the loader 215 may load the binary representations of the metadata labels into the metadata memory 125, and may record the mapping between application memory addresses and metadata memory addresses in the tag map table 142. For instance, the loader 215 may create an entry in the tag map table 142 that maps an application memory address where an instruction is stored in the application memory 120, to a metadata memory address where metadata associated with the instruction is stored in the metadata memory 125. Additionally, or alternatively, the loader 215 may store metadata in the tag map table 142 itself (as opposed to the metadata memory 125), to allow access without performing any memory operation.

In some embodiments, the loader 215 may initialize the tag register file 146 in addition to, or instead of, the tag map table 142. For instance, the tag register file 146 may include a plurality of registers corresponding, respectively, to a plurality of entities. The loader 215 may identify, from the initialization specification, metadata associated with the entities, and store the metadata in the respective registers in the tag register file 146.

With reference again to the example of FIG. 1, the loader 215 may, in some embodiments, load policy code (e.g., as output by the policy compiler 220) into the metadata memory 125 for execution by the policy processor 150. Additionally, or alternatively, a separate memory (not shown in FIG. 1) may be provided for use by the policy processor 150, and the loader 215 may load policy code and/or associated data into the separate memory.

In some embodiments, a metadata label may be based on multiple metadata symbols. For instance, an entity may be subject to multiple policies, and may therefore be associated with different metadata symbols corresponding, respectively, to the different policies. The inventors have recognized and appreciated that it may be desirable that a same set of metadata symbols be resolved by the loader 215 to a same binary representation (which is sometimes referred to herein as a “canonical” representation). For instance, a metadata label {A, B, C} and a metadata label {B, A, C} may be resolved by the loader 215 to a same binary representation. In this manner, metadata labels that are syntactically different but semantically equivalent may have the same binary representation.

The inventors have further recognized and appreciated it may be desirable to ensure that a binary representation of metadata is not duplicated in metadata storage. For instance, as discussed above, the illustrative rule cache 144 in the example of FIG. 1 may map input tags to output tags, and, in some embodiments, the input tags may be metadata memory addresses where binary representations of metadata are stored, as opposed to the binary representations themselves. The inventors have recognized and appreciated that if a same binary representation of metadata is stored at two different metadata memory addresses X and Y, the rule cache 144 may not “recognize” the metadata memory address Y even if the rule cache 144 already stores a mapping for the metadata memory address X. This may result in a large number of unnecessary rule cache misses, which degrades system performance.

Moreover, the inventors have recognized and appreciated that having a one-to-one correspondence between binary representations of metadata and their storage locations may facilitate metadata comparison. For instance, equality between two pieces of metadata may be determined simply by comparing metadata memory addresses, as opposed to comparing binary representations of metadata. This may result in significant performance improvement, especially where the binary representations are large (e.g., many metadata symbols packed into a single metadata label).

Accordingly, in some embodiments, the loader 215 may, prior to storing a binary representation of metadata (e.g., into the metadata memory 125), check if the binary representation of metadata has already been stored. If the binary representation of metadata has already been stored, instead of storing it again at a different storage location, the loader 215 may refer to the existing storage location. Such a check may be done at startup and/or when a program is loaded subsequent to startup (with or without dynamic linking).

Additionally, or alternatively, a similar check may be performed when a binary representation of metadata is created as a result of evaluating one or more policies (e.g., by the illustrative policy processor 150). If the binary representation of metadata has already been stored, a reference to the existing storage location may be used (e.g., installed in the illustrative rule cache 144).

In some embodiments, the loader 215 may create a hash table mapping hash values to storage locations. Before storing a binary representation of metadata, the loader 215 may use a hash function to reduce the binary representation of metadata into a hash value, and check if the hash table already contains an entry associated with the hash value. If so, the loader 215 may determine that the binary representation of metadata has already been stored, and may retrieve, from the entry, information relating to the binary representation of metadata (e.g., a pointer to the binary representation of metadata, or a pointer to that pointer). If the hash table does not already contain an entry associated with the hash value, the loader 215 may store the binary representation of metadata (e.g., to a register or a location in a metadata memory), create a new entry in the hash table in association with the hash value, and store appropriate information in the new entry (e.g., a register identifier, a pointer to the binary representation of metadata in the metadata memory, a pointer to that pointer, etc.). However, it should be appreciated that aspects of the present disclosure are not limited to the use of a hash table for keeping track of binary representations of metadata that have already been stored. Additionally, or alternatively, other data structures may be used, such as a graph data structure, an ordered list, an unordered list, etc. Any suitable data structure or combination of data structures may be selected based on any suitable criterion or combination of criteria, such as access time, memory usage, etc.

It should be appreciated that the techniques introduced above and discussed in greater detail below may be implemented in any of numerous ways, as the techniques are not limited to any particular manner of implementation. Examples of details of implementation are provided herein solely for illustrative purposes. Furthermore, the techniques disclosed herein may be used individually or in any suitable combination, as aspects of the present disclosure are not limited to the use of any particular technique or combination of techniques.

For instance, while examples are discussed herein that include a compiler (e.g., the illustrative compiler 205 and/or the illustrative policy compiler 220 in the example of FIG. 2), it should be appreciated that aspects of the present disclosure are not so limited. In some embodiments, a software toolchain may be implemented as an interpreter. For example, a lazy initialization scheme may be implemented, where one or more default symbols (e.g., “UNINITIALIZED”) may be used for tagging at startup, and a policy processor (e.g., the illustrative policy processor 150 in the example of FIG. 1) may evaluate one or more policies and resolve the one or more default symbols in a just-in-time manner.

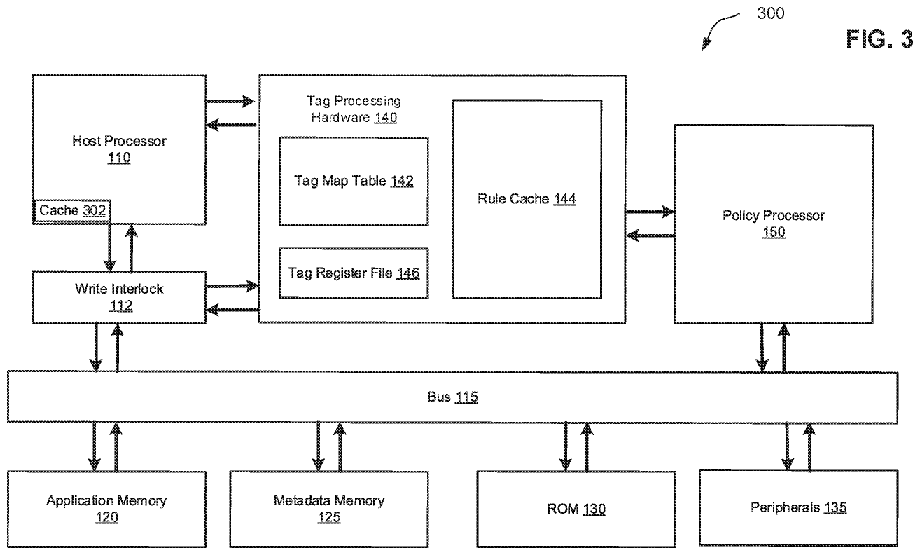

FIG. 3 shows an illustrative hardware system 300 for enforcing policies, in accordance with some embodiments. The hardware system 300 may include components similar to the hardware system 100 shown in FIG. 1. The hardware system 300 may further include a data cache, cache 302, associated with the host processor 110. The write interlock 112 may be configured to enforce policies for a processor that includes a data cache, such as the cache 302. For example, the write interlock 112 may enforce one or more security policies for a store instruction. However, it should be appreciated that aspects of the present disclosure are not limited to the use of the write interlock for instructions that are store instructions. For example, the write interlock 112 may be used for other instructions, such as a load instruction or another suitable instruction.

The inventor has recognized that it may be beneficial to provide a write interlock to a host processor that includes a cache. Providing such a feature may not be straightforward because the memory side of the cache may see fewer accesses than the host processor side, and the order of these accesses may not reflect the order of the host processor's instruction execution. The presence of the cache may enable the host processor to write a word of data many times over, and consume that word of data many times over, before a version of that word of data ever leaves the cache, if any version ever does. Moreover, since cache evictions may happen when a particular line of the cache is needed for holding a data line for a new address, writes out of the cache to main memory may be out of order with respect to instructions that modified data in that line.

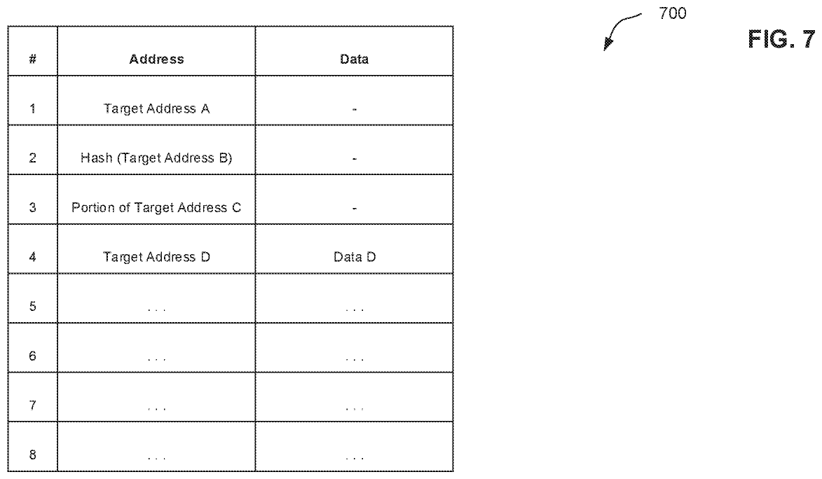

The inventor has recognized that it may be challenging to provide an interlock that is able to determine when it is safe to allow a write-back event from the host processor's cache to proceed to the rest of the system given that the write-back event includes data that that may have been written and/or consumed many times over within the cache before the write back to main memory. The illustrative write interlock 112 discussed with respect to FIG. 3 provides a solution where, for example, the host processor's cache may complete the store instruction when it is determined that the store instruction should be allowed to proceed. Such operations may be stalled while the associated instruction is pending validation against the relevant policies. A data structure, called a “blacklist,” a “scorecard,” or another suitable term, is used to ensure that no data is written back to an address by the host processor's cache for which a store instruction is currently pending validation. FIG. 7 shows an illustrative scorecard 700, in accordance with some embodiments. While this data structure is referred to as a “scorecard” in some embodiments described in this disclosure, it may be referred to as a “blacklist” or another suitable term for such a data structure. This data structure is described in further detail below.

In some embodiments, the write interlock 112 may receive a store instruction from the host processor 110. The store instruction may include a target address to which data is to be stored. The write interlock 112 may store an entry corresponding to the store instruction in a data structure. The data structure may be implemented as a hardware component or in a portion of memory accessible to the write interlock 112. The data structure may be implemented within or outside the write interlock 112. Such a data structure may be implemented as a table, a queue, a stack, or using another suitable technique. The entry corresponding to the store instruction may include information relating to the target address. For example, the data structure may take the form of a “scorecard” that is indexed by address, where each entry in the scorecard is associated with the target address of the respective store instruction. The entries may include and/or be indexed by the target address, a portion of the target address, a hash of the target address or the portion of the target address, or other another suitable index relating to the target address. In some embodiments, the host trace interface (HTI) may present a virtual address while the host processor's data cache may present a physical address. As such, the write interlock 112 may be capable of virtual-to-physical address translation, e.g., by using a Translation Lookaside Buffer (TLB) and page table walker hardware. In some embodiments, if the addresses presented by the HTI and the data cache do not match, the entries in the scorecard may include a common portion of the addresses from the HTI and the data cache. For example, the entries in the scorecard may include a common portion of a virtual address from the HTI and a physical address from the data cache, e.g., same lower address bits from both addresses.

In some embodiments, the entry in the data structure may indicate that the target address may have a write pending from an instruction not yet validated against policies and, therefore a write to the target address by the host processor 110 is unsafe. Allowing such a write to the target address would be problematic because at least the current store instruction's write to the target address may still be pending. It is not yet known if the instruction that generated the data being written violates any policies. In some embodiments, the data need not be stored in this data structure. Such a data structure may be significantly smaller than a data structure that stores the full address as well as the data to be stored to that address. FIG. 7 shows an illustrative scorecard 700, in accordance with some embodiments. In this scorecard, “Target Address A” is stored in the first entry, but there is no corresponding data stored for this address because it may not be required for this particular write interlock implementation. A hash of “Target Address B” is stored in the second entry, instead of the full “Target Address B.” Again, there is no corresponding data stored for this address because it may not be required for this particular write interlock implementation. A portion of “Target Address C” is stored in the third entry, instead of the full “Target Address C.” Again, there is no corresponding data stored for this address because it may not be required for this particular write interlock implementation. In some embodiments, the scorecard 700 may only include storage for the address, a hash of the address, a portion of the address, or another suitable index, and need not include storage for the corresponding data.

In some embodiments, the write interlock 112 may cause the write transaction from the host processor 110 to be stalled. For example, the write interlock 112 may request bus 115 to stall the write transaction. In some embodiments, bus 115 may implement the Advanced Extensible Interface (AXI) bus protocol to provide for the capability to stall the write transaction. In some embodiments, the write interlock 112 may cause the write transaction to be stalled while waiting on a check of the store instruction against one or more policies.

In some embodiments, the write interlock 112 may perform two decoupled sets of processing steps. The first set of processing steps may relate to determining when the target address of the store instruction turns from unsafe to safe for writing. The first set of processing steps need not be limited to checking the store instruction against relevant policies and instead may cover any type of check that would turn the target address of the store instruction from unsafe to safe. The second set of processing steps may relate to checking whether the target address of the write transaction from the host processor 110 is unsafe for writing, and therefore the write transaction should continue to be stalled.

In some embodiments, the write interlock 112 may perform the first set of processing steps by receiving information relating to a store instruction from the host processor 110. The information relating to the store instruction may include a target address. The write interlock 112 may store an entry corresponding to the target address of the store instruction in the data structure. The write interlock 112 may initiate a check of the store instruction against one or more policies. In some embodiments, the write interlock 112 may request the tag processing hardware 140 to ensure that the store instruction being executed by the host processor 110 complies with one or more policies, as described with respect to FIG. 1. In some embodiments, while the tag processing hardware 140 checks compliance of the store instruction, the host processor 110 may be stalled from executing further instructions. If the tag processing hardware 140 determines that the store instruction in question should be allowed (e.g., based on a hit in the rule cache 144, or a response from the policy processor 150), the tag processing hardware 140 may indicate to the write interlock 112 that the store instruction complies with the relevant policies. In response to receiving the indication of successful completion of the check of the store instruction, the write interlock 112 may remove the entry corresponding to the address of the store instruction from the data structure.

In some embodiments, the write interlock 112 may perform the second set of processing steps by receiving a write transaction including a target address to which data is to be written from the host processor 110. The write interlock 112 may determine whether there is any entry in the data structure relating to the target address of the write transaction. For example, the write interlock 112 may index the data structure using the target address of the write transaction from the host processor 110 to determine whether there is any entry relating to the address. If write interlock 112 determines there is no entry in the data structure that relates to the target address of the write transaction, the write interlock 112 may cause the data to be written to the target address of the write transaction. For example, the write interlock 112 may request bus 115 to release the write transaction. In some embodiments, bus 115 may implement the AXI bus protocol to provide for the capability to release the write transaction. Accordingly, a result of executing the write transaction may be written back to memory. If write interlock 112 determines there is an entry in the data structure that relates to the target address, the write interlock 112 may continue to stall the write transaction, for example, until the tag processing hardware 140 returns an indication that the instruction relating to that address complies with relevant policies.

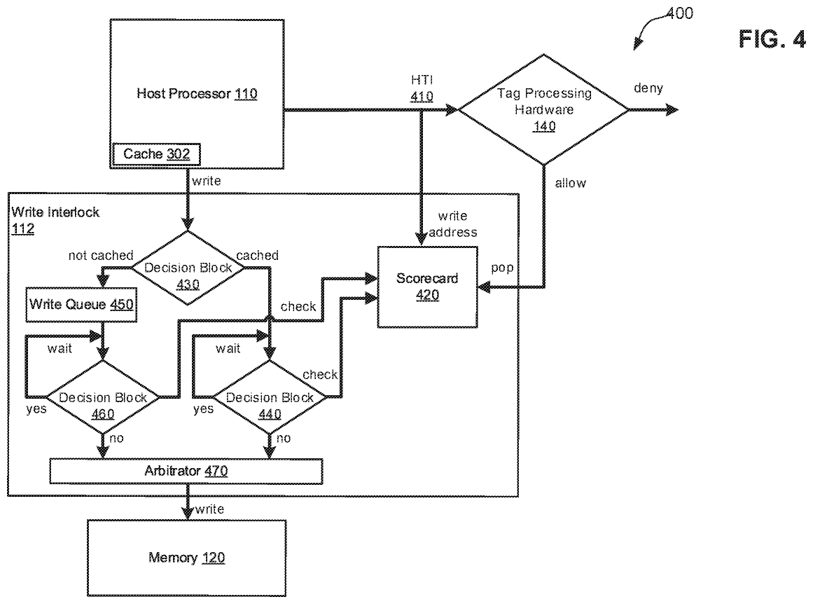

FIG. 4 shows an illustrative block diagram 400 for enforcing policies, in accordance with some embodiments. The block diagram 400 illustrates the decoupled execution of the first processing steps and the second processing steps discussed with respect to FIG. 3. In this embodiment of the write interlock 112, for example, the host processor's cache 302 may complete the write transaction when it is determined that the write transaction should be allowed to proceed. Such transactions may be stalled while the associated instruction is pending validation against the relevant policies. Scorecard 420 is used to ensure that no data is written back to an address by the host processor's cache for which a store instruction is currently pending validation.

In some embodiments, the write interlock 112 may perform two decoupled sets of processing steps. The first set of processing steps may relate to the write interlock 112 receiving information relating to a store instruction from the host processor 110 via a HTI 410. The information relating to the store instruction may include a target address. The write interlock 112 may store an entry corresponding to the target address of the store instruction in the scorecard 420. The tag processing hardware 140 may determine when the target address of the store instruction turns from unsafe to safe for writing. In some embodiments, the write interlock 112 may request the tag processing hardware 140 to ensure that the store instruction being executed by the host processor 110 complies with one or more policies, as described with respect to FIG. 1. In some embodiments, while the tag processing hardware 140 checks compliance of the store instruction, the host processor 110 may be stalled from executing further instructions. If the tag processing hardware 140 determines that the store instruction in question should be allowed (e.g., based on a hit in the rule cache 144, or a response from the policy processor 150), the tag processing hardware 140 may indicate to the write interlock 112 that the store instruction complies with the relevant policies. In response to receiving the “allow” indication of successful completion of the check of the store instruction, the write interlock 112 may remove the entry corresponding to the address of the store instruction from the scorecard 420. If the tag processing hardware 140 determines that the store instruction in question should be denied (e.g., based on a violation detected by the policy processor 150), the tag processing hardware 140 may indicate to the write interlock 112 that the store instruction does not comply with the relevant policies. In response to receiving the “deny” indication for the check of the store instruction, the write interlock 112 may request host processor 110 to initiate suitable violation processing code. An illustrative process for requesting violation processing is described later in the disclosure.

The second set of processing steps may relate to a decision block 440 determining whether the target address of the write transaction from the host processor 110 is unsafe for writing and the write transaction should continue to be stalled. In some embodiments, the write interlock 112 may receive a write transaction including a target address, to which data is to be written, from the host processor 110. In response to receiving the write transaction, the decision block 440 of the write interlock 112 may determine whether there is any entry in the scorecard 420 relating to the target address of the write transaction. For example, the decision block 440 and/or the write interlock 112 may index the scorecard 420 using the target address of the write transaction to determine whether there is any entry relating to the address. If the decision block 440 determines there is no entry in the scorecard 420 that relates to the target address of the write transaction, the decision block 440 may cause the data to be written to the target address of the write transaction in the memory 120. For example, the decision block 440 and/or write interlock 112 may request bus 115 to release the write transaction. In some embodiments, bus 115 may implement the AXI bus protocol to provide for the capability to release the write transaction. Accordingly, a result of executing the store instruction may be written back to the memory 120. In some embodiments, the write interlock 112 may receive the write transaction on a first interface, e.g., a first memory interface, and the data may be written to the target address of the write transaction via another write transaction on a second interface, different from the first interface. If the decision block 440 determines there is an entry in the scorecard 420 that relates to the target address, the decision block 440 may continue to stall the write transaction, for example, until the tag processing hardware 140 returns an indication that the instruction relating to that address complies with relevant policies.

In some embodiments, the second set of processing steps may further relate to a decision block 430 determining whether the target address of the write transaction is cached. In some embodiments, the decision block 430 may determine whether the target address of the write transaction is cached by determining whether the target address of the write transaction is included in an address range for non-cached addresses. In some embodiments, the decision block 430 may determine whether the target address of the write transaction is cached by determining whether a signal from a data cache of host processor 110 indicates the target address of the write transaction as cached. If the decision block 430 determines that the target address of the write transaction is cached, the second set of processing steps may proceed to the decision block 440, as described above. If the decision block 430 determines that the target address of the write transaction is not cached, the data of the write transaction may be stored in a write queue 450. In some embodiments, the write interlock 112 may acknowledge the write transaction to the host processor 110, but discard the data of the write transaction. After storing the data of the write transaction in the write queue 450, the write interlock 112 may proceed to the decision block 460, as described further below. The write interlock 112 may include an arbitrator 470 to select between data output from the decision block 440 and the decision block 460 to be written to the memory 120. If the target address of the write transaction is cached, the arbitrator 470 may select the data output from the decision block 440. If the target address of the write transaction is not cached, the arbitrator 470 may select the data output from the decision block 460.

In some embodiments, the decision block 460 may determine whether the target address of the write transaction from the host processor 110 is unsafe for writing and the write transaction should continue to be stalled. The decision block 460 of the write interlock 112 may determine whether there is any entry in the scorecard 420 relating to the target address of the write transaction. For example, the decision block 460 and/or the write interlock 112 may index the scorecard 420 using the target address of the write transaction to determine whether there is any entry relating to the address. If the decision block 460 determines there is no entry in the scorecard 420 that relates to the target address of the write transaction, the decision block 460 may cause the data to be written to the target address of the write transaction in the memory 120. Accordingly, the data of the store instruction may be written to the memory 120. In some embodiments, the write interlock 112 may receive the write transaction on a first interface, e.g., a first memory interface, and the data may be written to the target address of the write transaction via another write transaction on a second interface, different from the first interface.

If the decision block 460 determines there is an entry in the scorecard 420 that relates to the target address, the decision block 460 may continue to stall the write transaction, for example, until the tag processing hardware 140 returns an indication that the instruction relating to that address complies with relevant policies. In some embodiments, the write transaction may be stalled for a period of time that is selected based on an estimated amount of time between the host processor 110 executing the store instruction and the store instruction being stored by the write interlock 112 in the data structure in the first processing. In some embodiments, the write transaction may be stalled until a selected number of instructions has been received from the host processor 110 in the first processing.

In some embodiments, the write interlock 112 may be implemented to handle a store instruction including a non-cached target address without use of a scorecard. The write interlock 112 may receive information relating to a store instruction from the host processor 110 via the HTI 410. The information relating to the store instruction may include a target address that is not cached. The write interlock 112 may store the data in the write queue 450. In some embodiments, the write interlock 112 may determine whether the target address is cached, and the data may be stored in an entry in the write queue 450 in response to determining that the target address is not cached. The write interlock 112 may request the tag processing hardware 140 to ensure that the store instruction being executed by the host processor 110 complies with one or more policies, as described with respect to FIG. 1. If the tag processing hardware 140 determines that the store instruction in question should be allowed (e.g., based on a hit in the rule cache 144, or a response from the policy processor 150), the tag processing hardware 140 may indicate to the write interlock 112 that the store instruction complies with the relevant policies. In response to receiving the “allow” indication of successful completion of the check of the store instruction, the write interlock 112 may cause a write transaction to write the data to the target address. For example, the write interlock 112 may request bus 115 to cause the write transaction to write the data to the target address. In some embodiments, bus 115 may implement the AXI bus protocol to provide for the capability to cause the write transaction to write the data to the target address. Accordingly, a result of executing the store instruction may be written back to the memory 120. In some embodiments, the data written by the write transaction is retrieved from the entry in the write queue 450. In some embodiments, after retrieving the data for the write transaction, the entry storing the data is removed from the write queue 450. In some embodiments, the write interlock 112 may acknowledge the write transaction to the host processor 110, but discard the data of the write transaction.

In some embodiments, the write interlock 112 interacts with two different interfaces for receiving and writing data relating to write transactions. For example, the write interlock 112 may receive a first write transaction on a first interface, e.g., a first memory interface. In some embodiments, in response to the write interlock 112 determining that the target address of the write transaction is cached, the write interlock 112 may cause the first write transaction to be stalled until it is determined that no entry in the data structure relates to the target address of the write transaction. In response to the write interlock 112 determining that no entry in the data structure relates to the target address of the write transaction, the write interlock 112 may cause the data to be written to the target address of the write transaction via a second write transaction on a second interface, different from the first interface.

In some embodiments, in response to the write interlock 112 determining that the target address of the write transaction is not cached, the write interlock 112 may store the first write transaction in a write queue and acknowledge the first write transaction to the processor. In response to the write interlock 112 determining that no entry in the data structure relates to the target address of the write transaction, the write interlock 112 may cause the data to be written to the target address of the write transaction via a second write transaction on a second interface. In some embodiments, the data written by the second write transaction is retrieved from an entry in the write queue storing the first write transaction. In some embodiments, after retrieving the data for the second write transaction, the write interlock 112 may remove the entry storing the first write transaction from the write queue. In some embodiments, the write interlock 112 may acknowledge the write transaction to the processor, but discard the data of the write transaction.

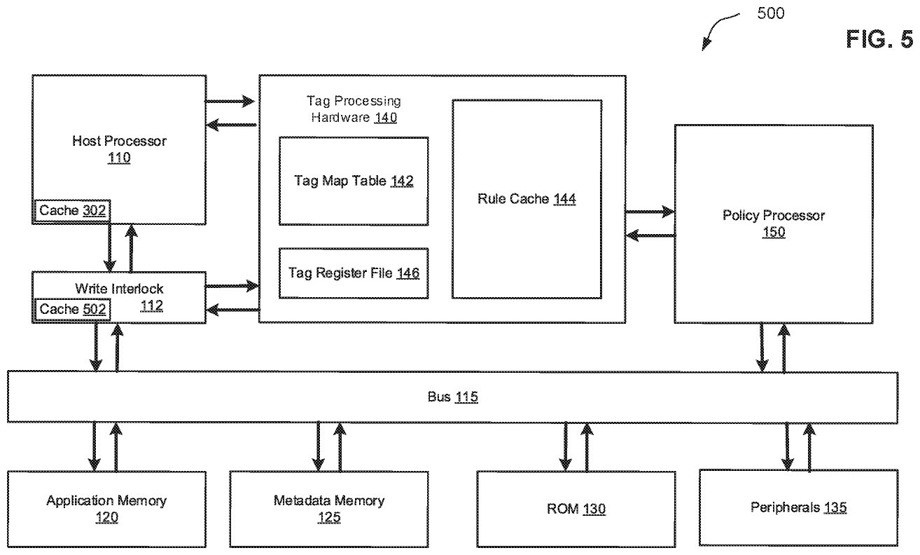

FIG. 5 shows an illustrative hardware system 500 for enforcing policies, in accordance with some embodiments. Illustrative hardware system 500 may include components similar to illustrative hardware system 100 shown in FIG. 1. In this example, hardware system 500 further includes a data cache, cache 302, associated with the host processor 110, and cache 502, associated with the write interlock 112. The write interlock 112 may be configured to enforce policies for a processor that includes a data cache, such as the cache 302. For example, the write interlock 112 may be configured to enforce one or more security policies for a store instruction. However, it should be appreciated that aspects of the present disclosure are not limited to the use of the write interlock for instructions that are store instructions. For example, the write interlock 112 may be used for other instructions, such as a load instruction or another suitable instruction.

The inventor has recognized that the problem to solve is how the interlock can know when it is safe to allow a write-back event from the host processor's cache to proceed to the rest of the system given that the write-back event includes data that that may have been written and/or consumed many times over within the cache before the write back to main memory. The write interlock 112 discussed with respect to FIG. 5 provides a solution where all write-back transfers from the host processor's cache are discarded and instead all memory operations are initiated from a cache, such as a write-back cache or another suitable cache, associated with the write interlock 112 once the associated instruction has been validated against the relevant policies.

In some embodiments, the write interlock 112 may receive a store instruction from the host processor 110. The store instruction may include a target address and data to be stored to that address. The write interlock 112 may store an entry corresponding to the store instruction in a data structure. The data structure may be implemented as a hardware component or in a portion of memory accessible to the write interlock 112. The data structure may be implemented within or outside the write interlock 112. Such a data structure may be implemented as a table, a queue, a stack, or another suitable data structure. The entry corresponding to the store instruction may include the target address of the store instruction and the data to be stored to that address. The entry in the data structure may indicate that the target address has a write pending and therefore a read from the target address by any instruction from the host processor 110 or any transaction from the host processor 110 is stale. Allowing such a read from the target address would be problematic because at least the current store instruction's write to the target address is still pending. The host processor is unaware of this pending status and therefore unable to mitigate coherency issues. In some embodiments, in response to storing the entry in the data structure, the write interlock 112 may return an indication to the host processor 110 that the store instruction has been completed. In some embodiments, the write interlock 112 takes no additional action in response to storing the entry in the data structure. In some embodiments, the store instruction results in write data and address flowing from the host processor to the tag processing hardware via the HTI. Optionally, the host processor may receive back an acknowledge signal. Accordingly, the host processor may register the instruction as fully written and retired and subsequent reads may read the new data for this address. FIG. 7 shows an illustrative scorecard 700, in accordance with some embodiments. In this scorecard, “Target Address D” is stored in the fourth entry, along with “Data D” to be stored to this target address because it may be required for this particular write interlock implementation. In this embodiment, the scorecard 700 includes storage for the target address and the data to be stored to that address.

In some embodiments, the write interlock 112 may perform two decoupled sets of processing steps. The first set of processing steps may relate to determining when the target address of the store instruction is no longer stale for reading. The first set of processing steps need not be limited to checking the store instruction against relevant policies and instead may cover any type of check that would indicate that the target address of the store instruction is no longer stale. The second set of processing steps may relate to checking whether the target address of the store instruction is unsafe for reading and a read transaction or a load instruction attempting to read data from the target address should be stalled. In some embodiments, the write interlock 112 may perform the first set of processing steps by receiving a store instruction including a target address and data to be stored to the target address of the store instruction from the host processor 110. The write interlock 112 may store an entry corresponding to the store instruction in the data structure. The entry may include the target address of the store instruction and the data. The write interlock 112 may initiate a check of the store instruction against one or more policies. In some embodiments, the write interlock 112 may request the tag processing hardware 140 to ensure that the store instruction being executed by the host processor 110 complies with one or more policies, as described with respect to FIG. 1. If the tag processing hardware 140 determines that the store instruction in question should be allowed (e.g., based on a hit in the rule cache 144, or a response from the policy processor 150), the tag processing hardware 140 may indicate to the write interlock 112 that the store instruction complies with the relevant policies.

In response to receiving the indication of successful completion of the check of the store instruction, the write interlock 112 may remove the entry corresponding to the store instruction from the data structure and store the data in a cache, e.g., a write-back cache or another suitable cache, associated with the write interlock 112. For example, the write interlock 112 may store at least a portion of the target address (e.g., an index portion of the target address) and the data to be stored to that address in a cache associated with the write interlock 112, such as the cache 502. In some embodiments, the cache 502 may be referred to as the write-back cache or another suitable term for a cache associated with the write interlock 112. In some embodiments, the cache 502 may be included within the write interlock 112. In some embodiments, the cache 502 may be implemented outside the write interlock 112. In some embodiments, the cache may be limited to a line buffer or may be implemented as a fully associative cache, a set associate cache, or another suitable type of cache. In some embodiments, cache 502 need not be as large as the host processor 110's cache, e.g., cache 302, because its use may be limited to storing address and data entries relating to write instructions.

In some embodiments, the write interlock 112 may perform the second set of processing steps by receiving a read transaction including a target address from which data is to be read from the host processor 110. The write interlock 112 may determine whether there is any entry in the data structure relating to the target address of the read transaction received from the host processor 110. The read transaction may be caused by a load instruction, a store instruction, or another suitable instruction. A store instruction may cause a read transaction if the host processor's data cache does not have a cached line including the address of the store instruction. In such a case, the host processor's data cache may read the line from the memory into the cache and then modify the portion of the line requested by the store instruction. For example, the write interlock 112 may receive an indication of a load instruction relating to the target address and may index the data structure using the target address of the store instruction to determine whether there is an entry relating to the target address. If there are one or more entries in the data structure that relates to the target address(es) of the read transaction, the read transaction may be stalled until no entry in the data structure relates to the target address of the read transaction. For example, bus 115 may stall the read transaction. In some embodiments, bus 115 may implement the AXI bus protocol to provide for the capability to stall the read transaction. In some embodiments, if the write interlock 112 determines that there are one or more entries in the data structure that relate to the target address of the read transaction, the write interlock 112 may cause the read transaction to access data from a most recent entry of the data structure related to the target address of the read transaction. If write interlock 112 determines there are no entries in the data structure that relate to the target address of the read transaction, the write interlock 112 may cause the read transaction to access data in the cache 502 associated with the write interlock 112. For example, the write interlock 112 may request bus 115 to allow the read transaction to access data in the cache associated with the write interlock 112. In some embodiments, bus 115 may implement the AXI bus protocol to provide for the capability to allow the read transaction to access data in the cache associated with the write interlock 112.

In some embodiments, at a time subsequent to storing the address and the data to be stored to that address in the cache 502, associated with the write interlock 112, may determine whether the address and the data are to be evicted. In some embodiments, the write interlock 112 may determine the need to evict or invalidate a line in the cache 502 based on cache management instructions retired by the host processor 110. For example, the write interlock 112 may determine that a cache line, storing the address and the data in cache 502, is full and needs to be evicted. If the write interlock 112 determines that the address and the data are to be evicted, the write interlock 112 removes the address and the data from the cache and causes the data to be stored to the address in the memory 120. For example, the write interlock 112 may evict the cache line storing the address and the data and generate a request to store the data to that address in the memory 120. In some embodiments, the write interlock 112 may request bus 115 to store the data to that address in the memory 120. Bus 115 may implement the AXI bus protocol to provide for the capability to store the data to the target address in the memory 120. Accordingly, a result of executing the store instruction may be written back to memory.

FIG. 6 shows an illustrative block diagram 600 for enforcing policies, in accordance with some embodiments. The block diagram 600 illustrates the decoupled execution of the first processing steps and the second processing steps discussed with respect to FIG. 5. In this embodiment of the write interlock 112, all write-back transfers from the host processor's cache 302 are discarded and instead all memory operations are initiated from the cache 502 associated with the write interlock 112 once the associated instruction has been validated against the relevant policies. The scorecard 620 is used to ensure that the host processor 110 does not request data for reading from an address that has a write still pending.

In some embodiments, the write interlock 112 may perform two decoupled sets of processing steps. The first set of processing steps may relate to the write interlock 112 receiving information relating to a store instruction from the host processor 110 via the HTI 610. The information relating to the store instruction may include a target address and data to be stored to that address. The write interlock 112 may store an entry corresponding to the target address of the store instruction and the data in the scorecard 620. The scorecard 620 may be implemented as a hardware component or in a portion of memory accessible to the write interlock 112. The entry in the scorecard 620 may indicate that the target address of the store instruction has a write pending and therefore a read from the target address may be stalled until the write is complete or may be completed by returning the most recent pending data from the scorecard. Allowing such a read from the target address would be problematic because at least the current store instruction's write to the target address is still pending and therefore the memory system would return stale data.

The write interlock 112 may determine when the target address of the store instruction is no longer stale for reading. In some embodiments, the write interlock 112 may request the tag processing hardware 140 to ensure that the store instruction being executed by the host processor 110 complies with one or more policies, as described with respect to FIG. 1. If the tag processing hardware 140 determines that the store instruction in question should be allowed (e.g., based on a hit in the rule cache 144, or a response from the policy processor 150), the tag processing hardware 140 may indicate to the write interlock 112 that the store instruction complies with the relevant policies. In response to receiving the “allow” indication of successful completion of the check of the store instruction, the write interlock 112 may remove the entry corresponding to the store instruction from the scorecard 620 and store the data in the cache 502 associated with the write interlock 112. If the tag processing hardware 140 determines that the store instruction in question should be denied (e.g., based on a violation detected by the policy processor 150), the tag processing hardware 140 may indicate to the write interlock 112 that the store instruction does not comply with the relevant policies. In response to receiving the “deny” indication for the check of the store instruction, the write interlock 112 may request host processor 110 to initiate suitable violation processing code. An illustrative process for requesting violation processing is described later in the disclosure.

The second set of processing steps may relate to the write interlock 112 receiving a read transaction including a target address from which data is to be read from the host processor 110. A decision block 630 may determine whether the target address of the store instruction is unsafe for reading and the read transaction from the host processor 110 attempting to read data from the target address should be stalled. In some embodiments, the decision block 630 of the write interlock 112 may determine whether there is any entry in the scorecard 620 relating to the target address of the read transaction received from the host processor 110. For example, the write interlock 112 may receive an indication of a read transaction from the host processor 110 relating to the target address and may index the scorecard 620 using the target address of the read transaction to determine whether there is an entry relating to the target address. If there is an entry in the scorecard 620 that relates to the target address of the read transaction, the read transaction may be stalled until no entry in the data structure relates to the target address of the read transaction. For example, bus 115 may stall the read transaction. In some embodiments, bus 115 may implement the AXI bus protocol to provide for the capability to stall the read transaction. In some embodiments, if the decision block 630 determines that there are one or more entries in the scorecard 620 that relate to the target address of the read transaction, the decision block 630 may cause the read transaction to access data from a most recent entry of the scorecard 620 related to the target address of the read transaction. If the decision block 630 determines there is no entry in the scorecard 620 that relates to the target address of the read transaction, the decision block 630 may cause the read transaction to access data in the cache 502 associated with the write interlock 112. For example, the decision block 630 and/or the write interlock 112 may request bus 115 to allow the read transaction to access the data in the cache 502 associated with the write interlock 112. In some embodiments, bus 115 may implement the AXI bus protocol to provide for the capability to allow the read transaction to access data in the cache 502 associated with the write interlock 112.

In some embodiments, the hardware systems discussed herein (e.g., the hardware system 100 in FIG. 1, the hardware system 300 in FIG. 3, and/or the hardware system 500 in FIG. 5) are configured to handle a policy violation that may occur when the tag processing hardware 140 returns an indication that an instruction does not comply with one or more policies. For example, the tag processing hardware 140 may return an indication that a store instruction is attempting to write to an address that is not designated as accessible for application data. If the tag processing hardware 140 determines that the instruction in question represents a policy violation (e.g., based on a hit in the rule cache 144, or a response from the policy processor 150), the tag processing hardware 140 may send an interrupt to the host processor 110. In response to receiving the interrupt, the host processor 110 may switch to any suitable violation processing code. For example, the host processor 100 may halt, reset, log the violation and continue, perform an integrity check on application code and/or application data, notify an operator, or perform another suitable action.

In some embodiments, when a policy violation occurs, the write interlock 112 may cause a snapshot of the scorecard to be saved to an address range accessible by the host processor 110's violation processing code. The snapshot may be saved in a number of ways. As one example, the write interlock 112 may store the snapshot of the scorecard to a dedicated physical memory block within the write interlock 112. This may require implementing a path for the host processor 110 to read one or more address ranges of the write interlock 112 relating to the memory block storing the snapshot. As another example, the write interlock 112 may automatically store the snapshot of the scorecard to a pre-configured memory location accessible to the host processor 110. As yet another example, the policy processor 150 may execute code to retrieve values from the scorecard via a Special Function Register (SFR) interface and store the snapshot of the scorecard to a memory location accessible to the host processor 110.

In some embodiments, the snapshot may be used by the host processor 110's violation processing code to invalidate data cache lines from the cache 302 that contain any of the addresses that were in the scorecard at the time of the violation. For example, the ARM instruction set architecture (ISA) provides for instructions that can invalidate cache data based on an address. In another example, the RISC-V ISA does not provide for such instructions and may require additional code and/or hardware in order to invalidate cache data based on an address. In some embodiments, for a host processor that does not provide for instructions to invalidate cache data based on an address, the write interlock 112 may enter a special mode upon detection of a policy violation where future memory writes may be acknowledged to cache 302 but are discarded and not sent to memory. This special mode may allow the host processor 110's violation processing code to work in conjunction with write interlock 112 to evict cache lines by reading other addresses that share the cache lines with addresses that were in the scorecard. In this manner, all data cache lines from the cache 302 that contain any of the addresses that were in the scorecard at the time of the violation may be evicted. In some embodiments, the write interlock 112 may exit the special mode when the policy processor 150 executes an instruction with a special metadata tag in the host processor 110's violation processing code. In some embodiments, in order to avoid this instruction from being addressed by rule cache 144, the rule cache 144 may purposely be prevented from being populated with any related mapping of input tag to decision and/or output tag. This would force the instruction with the special metadata tag to invoke the policy processor, which in turn may write to SFRs in the write interlock to make the write interlock exit the special mode.

In some embodiments, the write interlock 112 may store, to an address range accessible by the host processor 110's violation processing code, a snapshot of the scorecard at a time of a policy violation. The write interlock 112 may trigger an interrupt to the host processor 110 to initiate execution of the violation processing code. The interrupt may cause the host processor 110 to invalidate at least one data cache line from a data cache that includes at least one address that was in the scorecard at the time of the policy violation.

In some embodiments, the write interlock 112 may store, to an address range accessible by the host processor 110's violation processing code, a snapshot of the scorecard at a time of a policy violation. The write interlock 112 may trigger an interrupt to the host processor 110 to initiate execution of the violation processing code, and cause eviction, from a data cache, of at least one data cache line that includes at least one address that was in the scorecard at the time of the policy violation. The write interlock 112 may enter a violation handling mode where future writes to the memory 120 attempted by the host processor 110 are acknowledged to the host processor 110 but are discarded and not sent to the memory 120. The write interlock 112 may exit the violation handling mode in response to an indication that the host processor 110 has completed violation processing. In some embodiments, the indication may include a signal received from the host processor 110 indicating that the host processor 110 has completed violation processing. In some embodiments, the indication may include a determination that all data cache lines including at least one address that was in the scorecard at the time of the policy violation have been evicted.

In some embodiments, the write interlock implementation from the hardware system 500 of FIG. 5 may be advantageous over the write interlock implementation from the hardware system 300 of FIG. 3. In the hardware system 500 of FIG. 5, the write interlock 112 may store data for each store instruction in cache 502 upon instruction validation. When a policy violation is detected, the data and related addresses from policy-compliant instructions are present in the memory system, enabling the host processor 110 to be rewound to the last policy-compliant instruction before resuming execution with an exception at the policy violating instruction. This implementation of the write interlock may enable robust policy violation response options for the host processor 110, such as an alternate con-ops, violation logging, or another suitable policy violation response, while continuing execution of the offending thread. Without this data, a policy violation response may be to terminate the offending thread or reset the host processor 110.

In some embodiments, the host processor 110's violation processing code may execute an alternate con-op. For example, on detecting a violation, a host processor embedded in a missile may switch the guidance of the missile to projectile mode so that the offending code may not access the destructive potential of the missile. Additionally, the host processor may allow the missile to fall gracefully to avoid any further violations. In some embodiments, the host processor 110's violation processing code may selectively decide which data in the processor's cache may be affected by the violation and evict that data, while keeping data in the processor's cache not affected by the violation. In some embodiments, the host processor 110's violation processing code may initiate a logging mode where the offending thread is allowed to run and violations are captured and logged for future reference. For example, a developer may execute a software program to test whether the host processor 110's violation processing code detects any violations in the software program.

In some embodiments, the write interlock implementation from the hardware system 300 of FIG. 3 may be advantageous over the write interlock implementation from the hardware system 500 of FIG. 5. In the hardware system 300 of FIG. 3, the data is not stored in the “scorecard” data structure. Such a data structure may be significantly smaller than a data structure, such as the data structure used by hardware system 500 of FIG. 5, that stores the address as well as the data to be stored to that address. If the data structure were implemented in hardware, the write interlock implementation from the hardware system 300 of FIG. 3 would require less area and power to function. Additionally, the hardware system 300 of FIG. 3 is implemented without a cache associated with the write interlock, while the hardware system 500 of FIG. 5 requires a cache associated with the write interlock for its operation. This adds to the area and power savings for the write interlock implementation from the hardware system 300 of FIG. 3.

In some embodiments, in the hardware system 300 of FIG. 3, some writes by the host processor 110 may be overwritten in the cache 302 before a write-back operation happens. In the event of a policy violation, a violating instruction, or an instruction after the violation, may overwrite the last valid data value of a word or words. In such instances, the option of rewinding the host processor 110 to the point before the violation in order to replay the offending instruction as an exception may not be available.

In some embodiments, rewinding the host processor 110 back to the last valid instruction may not be implemented. This may be due to some processor state not captured by the interlock, such as Arithmetic Logic Unit (ALU) status flags. For example, the ARM ISA provides for instructions that use one or more ALU status flags (e.g., whether the result of the last operation was negative. was zero, resulted in a carry, or caused an overflow) as an input for their operation. In addition, threads that consume data via destructive reads may require a significant amount of hardware support to enable replaying those destructive data reads. Therefore, not doing a rewind may have limited impact for such embodiments.

In some embodiments, even without being rewound, the host processor 110's violation processing code may flush the cache of any data values that resulted from the violating instruction, or from instructions which followed it. To support this, the write interlock 112 may store a snapshot of the scorecard to a memory block within the write interlock 112. For this solution, the host processor 110's violation processing code need not have access to the snapshot. Instead, the host processor 110's violation processing code may flush and invalidate/overwrite all of the cache 302, and the write interlock 112, having entered violation mode, may discard any writes to addresses present in the snapshot of the scorecard. In some embodiments, the host processor 110's violation processing code may only flush cache lines indicated by the snapshot, which may require the host processor 110 to access a copy of the snapshot. Once the host processor 110 has flushed the cache 302, the currently executing thread may be terminated. In some embodiments, instead of terminating a thread that experiences a violation, the host processor 110's violation processing code may periodically snapshot the thread and restart the thread from that point, with a breakpoint set at the violating instruction address.

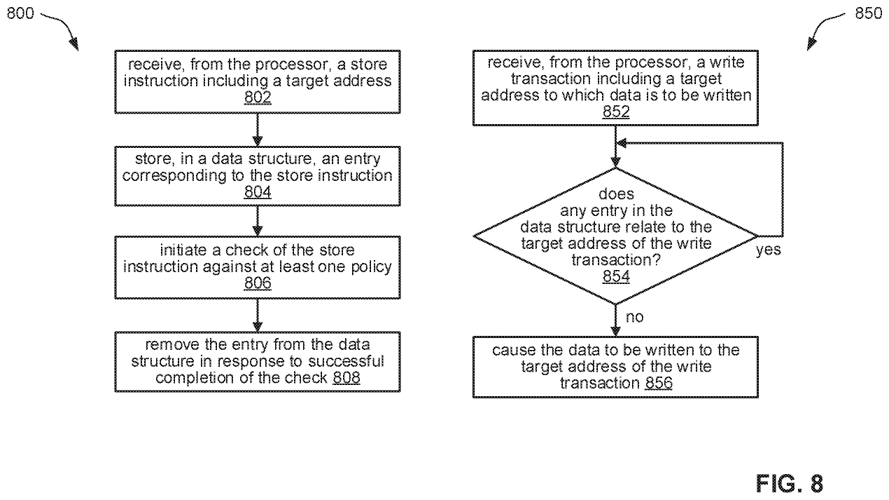

FIG. 8 shows illustrative flow diagrams 800 and 850 for enforcing policies, in accordance with some embodiments. The flow diagrams 800 and 850 correspond to a first set of processing steps and a second set of processing steps, decoupled from the first set of processing steps, e.g., as described with respect to FIG. 4, for execution by a write interlock, e.g., the write interlock 112. For example, the first set of processing steps may relate to determining when the target address of the store instruction turns from unsafe to safe for writing, and the second set of processing steps may relate to checking whether the target address of the write transaction from the processor is unsafe for writing, and the write transaction should continue to be stalled.

The flow diagram 800 corresponds to the first set of processing steps.

At 802, the write interlock 112 receives, from a processor, a store instruction including a target address. For example, the write interlock 112 may receive information relating to a store instruction from the host processor 110 via the HTI 410.

At 804, the write interlock 112 stores, in a data structure, an entry corresponding to the store instruction. The entry may include information relating to the target address of the store instruction, e.g., a portion of or the entire target address of the store instruction. For example, the write interlock 112 may store an entry corresponding to the target address of the store instruction in the scorecard 420.

At 806, the write interlock 112 initiates a check of the store instruction against at least one policy. For example, the write interlock 112 may request the tag processing hardware 140 to ensure that the store instruction being executed by the host processor 110 complies with one or more policies, as described with respect to FIG. 1.

At 808, the write interlock 112, removes the entry from the data structure in response to successful completion of the check. For example, if the tag processing hardware 140 determines that the store instruction in question should be allowed (e.g., based on a hit in the rule cache 144, or a response from the policy processor 150), the tag processing hardware 140 may indicate to the write interlock 112 that the store instruction complies with the relevant policies. In response to receiving the “allow” indication of successful completion of the check of the store instruction, the write interlock 112 may remove the entry corresponding to the address of the store instruction from the scorecard 420.

The flow diagram 850 corresponds to the second set of processing steps, which is decoupled from the first set of processing steps.

At 852, the write interlock 112 receives, from the processor, a write transaction including a target address to which data is to be written.

In some embodiments, the write interlock 112 determines whether the target address of the write transaction is cached. In some embodiments, the write interlock 112 determines whether the target address of the write transaction is cached by determining whether the target address of the write transaction is included in an address range for non-cached addresses. In some embodiments, the write interlock 112 determines whether the target address of the write transaction is cached by determining whether a signal from a data cache indicates the target address of the write transaction as cached.

At 854, the write interlock 112, determines whether any entry in the data structure relates to the target address of the write transaction. For example, the decision block 440 and/or the write interlock 112 may index the scorecard 420 using the target address of the write transaction to determine whether there is any entry relating to the target address. If it is determined that no entry in the data structure relates to the target address of the write transaction, the write interlock 112 proceeds to 856.

In some embodiments, if it is determined that at least one entry in the data structure relates to the target address of the write transaction, the write interlock 112 causes the write transaction to be stalled. In some embodiments, the write transaction is stalled for a period of time. The period of time is selected based on an estimated amount of time between the processor executing the store instruction and the store instruction being stored by the write interlock in the data structure in the first processing. In some embodiments, the write transaction is stalled until a selected number of instructions has been received from the processor in the first processing.

At 856, the write interlock 112 causes the data to be written to the target address of the write transaction. For example, the decision block 440 and/or write interlock 112 may request bus 115 to release the write transaction.

In some embodiments, the write transaction from the processor comprises a first write transaction, and is received by the write interlock 112 on a first interface. In response to determining that no entry in the data structure relates to the target address of the write transaction, the data is written to the target address of the write transaction via a second write transaction on a second interface.

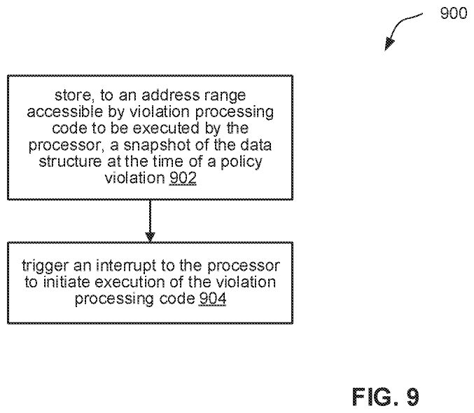

FIG. 9 shows an illustrative flow diagram 900 for handling a policy violation, in accordance with some embodiments. The flow diagram 900 corresponds to steps at the time of a policy violation for execution by a write interlock, e.g., the write interlock 112.

At 902, the write interlock 112 stores, to an address range accessible by violation processing code to be executed by the processor, a snapshot of the data structure at a time of a policy violation. The snapshot may be saved in a number of ways. As one example, the write interlock 112 may store the snapshot of the scorecard to a dedicated physical memory block within the write interlock 112. This may require implementing a path for the host processor 110 to read one or more address ranges of the write interlock 112 relating to the memory block storing the snapshot. As another example, the write interlock 112 may automatically store the snapshot of the scorecard to a pre-configured memory location accessible to the host processor 110. As yet another example, the policy processor 150 may execute code to retrieve values from the scorecard via a Special Function Register (SFR) interface and store the snapshot of the scorecard to a memory location accessible to the host processor 110.

At 904, the write interlock 112 triggers an interrupt to the processor to initiate execution of the violation processing code. In some embodiments, the interrupt causes the processor to invalidate at least one data cache line from a data cache that includes at least one address that was in the data structure at the time of the policy violation. For example, the ARM instruction set architecture (ISA) provides for instructions that can invalidate cache data based on an address.

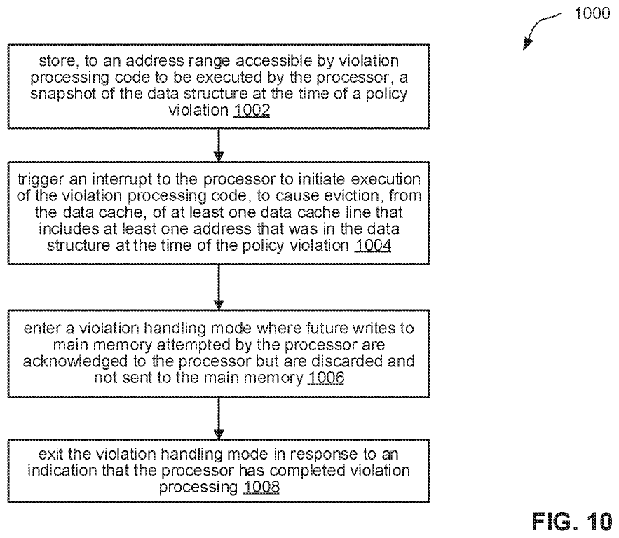

FIG. 10 shows an illustrative flow diagram 1000 for handling a policy violation, in accordance with some embodiments. The flow diagram 1000 corresponds to steps at the time of a policy violation for execution by a write interlock, e.g., the write interlock 112.

At 1002, the write interlock 112 stores, to an address range accessible by violation processing code to be executed by the processor, a snapshot of the data structure at a time of a policy violation. The snapshot may be saved in a number of ways. As one example, the write interlock 112 may store the snapshot of the scorecard to a dedicated physical memory block within the write interlock 112. This may require implementing a path for the host processor 110 to read one or more address ranges of the write interlock 112 relating to the memory block storing the snapshot. As another example, the write interlock 112 may automatically store the snapshot of the scorecard to a pre-configured memory location accessible to the host processor 110. As yet another example, the policy processor 150 may execute code to retrieve values from the scorecard via a Special Function Register (SFR) interface and store the snapshot of the scorecard to a memory location accessible to the host processor 110.

At 1004, the write interlock 112 triggers an interrupt to the processor to initiate execution of the violation processing code, to cause eviction, from a data cache, of at least one data cache line that includes at least one address that was in the data structure at the time of the policy violation. For example, the interrupt may be triggered for a host processor that does not provide for instructions to invalidate cache data based on an address, e.g., a processor based on the RISC-VISA.

At 1006, the write interlock 112 enters a violation handling mode where future writes to main memory attempted by the processor are acknowledged to the processor but are discarded and not sent to the main memory. For example, this special mode may allow the host processor 110's violation processing code to work in conjunction with write interlock 112 to evict cache lines by reading other addresses that share the cache lines with addresses that were in the scorecard.

At 1008, the write interlock 112, exits the violation handling mode in response to an indication that the processor has completed violation processing. For example, the write interlock 112 may exit the special mode when the policy processor 150 executes an instruction with a special metadata tag in the host processor 110's violation processing code.

In some embodiments, the indication comprises a signal received from the processor indicating that the processor has completed violation processing. In some embodiments, the indication comprises a determination that all data cache lines including at least one address that was in the data structure at the time of the policy violation have been evicted.

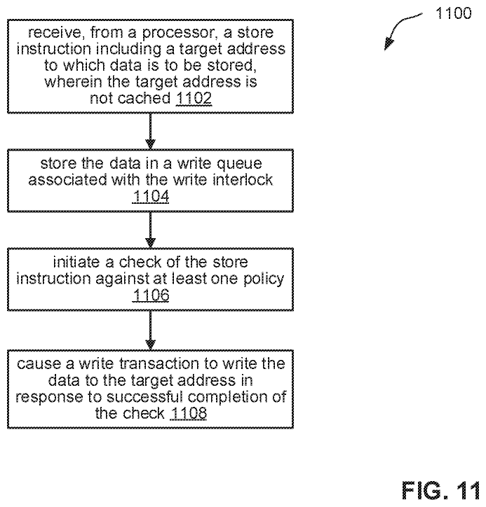

FIG. 11 shows an illustrative flow diagram 1100 for enforcing policies, in accordance with some embodiments. The flow diagram 1100 corresponds to steps for a store instruction including a non-cached target address for execution by a write interlock without use of a scorecard, e.g., the write interlock 112.

At 1102, the write interlock 112 receives, from a processor, a store instruction including a target address to which data is to be stored, wherein the target address is not cached. For example, the write interlock 112 may receive information relating to a store instruction from the host processor 110 via the HTI 410. The information relating to the store instruction may include a target address that is not cached.

At 1104, the write interlock 112 stores the data in a write queue associated with the write interlock. In some embodiments, the write interlock 112 may determine whether the target address is cached, and the data may be stored in the write queue in response to determining that the target address is not cached.

At 1106, the write interlock 112 initiates a check of the store instruction against at least one policy. For example, the write interlock 112 may request the tag processing hardware 140 to ensure that the store instruction being executed by the host processor 110 complies with one or more policies, as described with respect to FIG. 1.

At 1108, the write interlock 112 causes a write transaction to write the data to the target address in response to successful completion of the check. For example, if the tag processing hardware 140 determines that the store instruction in question should be allowed (e.g., based on a hit in the rule cache 144, or a response from the policy processor 150), the tag processing hardware 140 may indicate to the write interlock 112 that the store instruction complies with the relevant policies. In response to receiving the “allow” indication of successful completion of the check of the store instruction, the write interlock 112 may cause a write transaction to write the data to the target address.

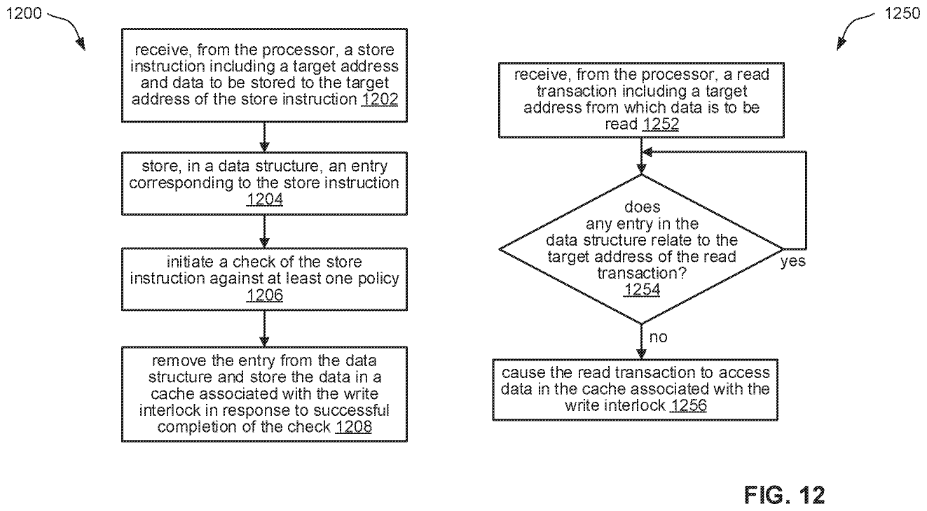

FIG. 12 shows illustrative flow diagrams 1200 and 1250 for enforcing policies, in accordance with some embodiments. The flow diagrams 1200 and 1250 correspond to a first set of processing steps and a second set of processing steps, decoupled from the first set of processing steps, e.g., as described with respect to FIG. 6, for execution by a write interlock, e.g., the write interlock 112. For example, the first set of processing steps may relate to determining when the target address of the store instruction is no longer stale for reading, and the second set of processing steps may relate to checking whether the target address of the store instruction is unsafe for reading and a read transaction attempting to read data from the target address should be stalled or handled in another suitable manner.

The flow diagram 1200 corresponds to the first set of processing steps.

At 1202, the write interlock 112 receives, from a processor, a store instruction including a target address and data to be stored to the target address of the store instruction. For example, the write interlock 112 may receive information relating to a store instruction from the host processor 110 via the HTI 610. The information relating to the store instruction may include a target address and data to be stored to that address.

At 1204, the write interlock 112 stores, in a data structure, an entry corresponding to the store instruction. The entry may include the target address of the store instruction and/or the data. For example, the write interlock 112 may store an entry corresponding to the target address of the store instruction and the data in the scorecard 620.

At 1206, the write interlock 112 initiates a check of the store instruction against at least one policy. For example, the write interlock 112 may request the tag processing hardware 140 to ensure that the store instruction being executed by the host processor 110 complies with one or more policies, as described with respect to FIG. 1.

At 1208, the write interlock 112 removes the entry from the data structure and stores the data in a cache associated with the write interlock in response to successful completion of the check. For example, if the tag processing hardware 140 determines that the store instruction in question should be allowed (e.g., based on a hit in the rule cache 144, or a response from the policy processor 150), the tag processing hardware 140 may indicate to the write interlock 112 that the store instruction complies with the relevant policies. In response to receiving the “allow” indication of successful completion of the check of the store instruction, the write interlock 112 may remove the entry corresponding to the store instruction from the scorecard 620 and store the data in the cache 502 associated with the write interlock 112.

The flow diagram 1250 corresponds to the second set of processing steps, which is decoupled from the first set of processing steps.

At 1252, the write interlock 112 receives, from the processor, a read transaction including a target address from which data is to be read.

At 1254, the write interlock 112 determines whether any entry in the data structure relates to the target address of the read transaction received from the processor. For example, the decision block 630 and/or the write interlock 112 may index the scorecard 620 using the target address of the read transaction to determine whether there is an entry relating to the target address. If it is determined that no entry in the data structure relates to the target address of the write transaction, the write interlock 112 proceeds to 1256.

In some embodiments, if it is determined that at least one entry in the data structure relates to the target address of the write transaction, the read transaction is stalled until no entry in the data structure relates to the target address of the read transaction. In some embodiments, if it is determined that at least one entry in the data structure relates to the target address of the write transaction, the write interlock 112 causes the read transaction to access data from a most recent entry of the data structure related to the target address of the read transaction.

At 1256, the write interlock 112 causes the read transaction to access data in the cache associated with the write interlock. For example, the decision block 630 and/or the write interlock 112 may request bus 115 to allow the read transaction to access the data in the cache 502 associated with the write interlock 112.

### Illustrative Computer

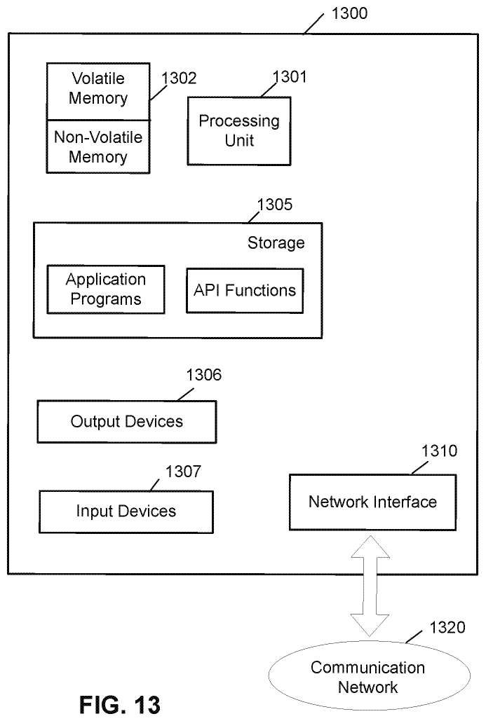

FIG. 13 shows, schematically, an illustrative computer 1300 on which any aspect of the present disclosure may be implemented.

In the embodiment shown in FIG. 13, the computer 1300 includes a processing unit 1301 having one or more processors and a non-transitory computer-readable storage medium 1302 that may include, for example, volatile and/or non-volatile memory. The memory 1302 may store one or more instructions to program the processing unit 1301 to perform any of the functions described herein. The computer 1300 may also include other types of non-transitory computer-readable medium, such as storage 1305 (e.g., one or more disk drives) in addition to the system memory 1302. The storage 1305 may also store one or more application programs and/or resources used by application programs (e.g., software libraries), which may be loaded into the memory 1302.

The computer 1300 may have one or more input devices and/or output devices, such as devices 1306 and 1307 illustrated in FIG. 13. These devices may be used, for instance, to present a user interface. Examples of output devices that may be used to provide a user interface include printers and display screens for visual presentation of output, and speakers and other sound generating devices for audible presentation of output. Examples of input devices that may be used for a user interface include keyboards and pointing devices (e.g., mice, touch pads, and digitizing tablets). As another example, the input devices 1307 may include a microphone for capturing audio signals, and the output devices 1306 may include a display screen for visually rendering, and/or a speaker for audibly rendering, recognized text.

In the example shown in FIG. 13, the computer 1300 also includes one or more network interfaces (e.g., the network interface 1310) to enable communication via various networks (e.g., the network 1320). Examples of networks include a local area network (e.g., an enterprise network) and a wide area network (e.g., the Internet). Such networks may be based on any suitable technology and operate according to any suitable protocol, and may include wireless networks and/or wired networks (e.g., fiber optic networks).

Furthermore, the present technology can be embodied in the following configurations:

(1) A method for execution by a write interlock, comprising acts of:

performing first processing and second processing, decoupled from the first processing, wherein:
the first processing comprises:
   receiving, from a processor, a store instruction including a target address;
   storing, in a data structure, a first entry corresponding to the store instruction, wherein the first entry includes information relating to the target address of the store instruction;
   initiating a check of the store instruction against at least one policy; and
   in response to successful completion of the check, removing the first entry from the data structure; and
the second processing comprises:
   receiving, from the processor, a write transaction including a target address to which data is to be written;
   in response to receiving the write transaction, determining whether any entry in the data structure relates to the target address of the write transaction; and
   in response to determining that no entry in the data structure relates to the target address of the write transaction, causing the data to be written to the target address of the write transaction.

(2) The method of (1), wherein the second processing further comprises: causing the write transaction to be stalled.

(3) The method of (2), wherein:

the write transaction is stalled for a period of time; and

the period of time is selected based on an estimated amount of time between the processor executing the store instruction and the store instruction being stored by the write interlock in the data structure in the first processing.

(4) The method of (2), wherein:

the write transaction is stalled until a selected number of instructions has been received from the processor in the first processing.

(5) The method of any one of (1) through (4), further comprising acts of:

storing, to an address range accessible by violation processing code to be executed by the processor, a snapshot of the data structure at a time of a policy violation; and

triggering an interrupt to the processor to initiate execution of the violation processing code.

(6) The method of (5), wherein:

the interrupt causes the processor to invalidate at least one data cache line from a data cache that includes at least one address that was in the data structure at the time of the policy violation.

(7) The method of any one of (1) through (4), further comprising acts of:

storing, to an address range accessible by violation processing code to be executed by the processor, a snapshot of the data structure at a time of a policy violation;

triggering an interrupt to the processor to initiate execution of the violation processing code, to cause eviction, from a data cache, of at least one data cache line that includes at least one address that was in the data structure at the time of the policy violation;

entering a violation handling mode where future writes to main memory attempted by the processor are acknowledged to the processor but are discarded and not sent to the main memory; and

in response to an indication that the processor has completed violation processing, exiting the violation handling mode.

(8) The method of (7), wherein:

the indication comprises a signal received from the processor indicating that the processor has completed violation processing.

(9) The method of (7), wherein:

the indication comprises a determination that all data cache lines including at least one address that was in the data structure at the time of the policy violation have been evicted.

(10) The method of any one of (1) through (9), wherein:

the write transaction from the processor comprises a first write transaction, and is received by the write interlock on a first interface; and

in response to determining that no entry in the data structure relates to the target address of the write transaction, the data is written to the target address of the write transaction via a second write transaction on a second interface.

(11) The method of any one of (1) through (9), wherein:

the write transaction from the processor comprises a first write transaction, and is received by the write interlock on a first interface;

the second processing further comprises acts of:
storing the first write transaction in a write queue; and
acknowledging the first write transaction to the processor; and

in response to determining that no entry in the data structure relates to the target address of the write transaction, the data is written to the target address of the write transaction via a second write transaction on a second interface.

(12) The method of (11), wherein:

the second processing further comprises an act of determining whether the target address of the write transaction is cached; and

the first write transaction is stored in the write queue in response to determining that the target address of the write transaction is not cached.

(13) The method of (11), wherein the data written by the second write transaction is retrieved from an entry in the write queue storing the first write transaction.

(14) The method of (13), wherein the second processing further comprises an act of:

after retrieving the data for the second write transaction, removing, from the write queue, the entry storing the first write transaction.

(15) The method of any one of (1) through (14), wherein:

the write interlock acknowledges the write transaction to the processor, but discards the data of the write transaction.

(16) The method of any one of (1) through (9) or (15), wherein:

the write transaction from the processor comprises a first write transaction, and is received by the write interlock on a first interface;

the second processing further comprises acts of:
determining whether the target address of the write transaction is cached; and
in response to determining that the target address of the write transaction is cached, causing the first write transaction to be stalled until it is determined that no entry in the data structure relates to the target address of the write transaction; and

in response to determining that no entry in the data structure relates to the target address of the write transaction, the data is written to the target address of the write transaction via a second write transaction on a second interface.

(17) The method of (16), wherein:

determining whether the target address of the write transaction is cached comprises determining whether the target address of the write transaction is included in an address range for non-cached addresses.

(18) The method of (16), wherein:

determining whether the target address of the write transaction is cached comprises determining whether a signal from a data cache indicates the target address of the write transaction as cached.

(19) The method of any one of (1) through (18), wherein:

a first destructive read instruction is performed;

a second destructive read instruction attempting to access a target address of the first destructive read instruction is stalled; and

in response to successful completion of a check of the first destructive read instruction, the second destructive read instruction is allowed to proceed.

(20) The method of any one of (1) through (18), wherein:

a destructive read instruction is executed and data read from a target address of the destructive read instruction is captured in a buffer; and

in response to successful completion of a check of the destructive read instruction, the data captured in the buffer is discarded.

(21) The method of (20), wherein:

in response to unsuccessful completion of the check of the destructive read instruction, the data captured in the buffer is restored to the target address.

(22) The method of (20), wherein:

in response to unsuccessful completion of the check of the destructive read instruction, a subsequent instruction attempting to access the target address of the destructive read instruction is provided the data captured in the buffer.

(23) A method for execution by a write interlock, comprising acts of:

receiving, from a processor, a store instruction including a target address to which data is to be stored, wherein the target address is not cached;

storing the data in a write queue associated with the write interlock;

initiating a check of the store instruction against at least one policy; and

in response to successful completion of the check, causing a write transaction to write the data to the target address.

(24) The method of (23), further comprising an act of:

determining whether the target address is cached, wherein the data is stored in the write queue in response to determining that the target address is not cached.

(25) A method for execution by a write interlock, comprising acts of:

performing first processing and second processing, decoupled from the first processing, wherein:
the first processing comprises:
   receiving, from a processor, a store instruction including a target address and data to be stored to the target address of the store instruction;
   storing, in a data structure, a first entry corresponding to the store instruction, wherein the first entry includes the target address of the store instruction and the data;
   initiating a check of the store instruction against at least one policy; and
   in response to successful completion of the check:
      removing the first entry from the data structure; and
      storing the data in a cache associated with the write interlock;
the second processing comprises:
   receiving, from the processor, a read transaction including a target address from which data is to be read;
   determining whether any entry in the data structure relates to the target address of the read transaction received from the processor; and
   in response to determining that no entry in the data structure relates to the target address of the read transaction, causing the read transaction to access data in the cache associated with the write interlock.

(26) The method of (25), wherein:

the read transaction is stalled until no entry in the data structure relates to the target address of the read transaction.

(27) The method of (25) or (26), wherein the second processing further comprises an act of:

in response to determining that at least one entry in the data structure relates to the target address of the read transaction, causing the read transaction to access data from a most recent entry of the data structure related to the target address of the read transaction.

(28) The method of any one of (25) through (27), wherein:

a data cache of the processor evicts a data cache line without performing a write transaction, independent of a state of a dirty bit for the data cache line.

(29) The method of any one of (25) through (28), wherein:

the write interlock acknowledges a write transaction from the data cache of the processor, but discards data relating to the write transaction.

As referred to herein, the term “in response to” may refer to initiated as a result of or caused by. In a first example, a first action being performed in response to a second action may include interstitial steps between the first action and the second action. In a second example, a first action being performed in response to a second action may not include interstitial steps between the first action and the second action.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B,” when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term).

The phraseology and terminology used herein is for the purpose of description and should not be regarded as limiting. The use of “including,” “comprising,” “having,” “containing,” “involving,” and variations thereof, is meant to encompass the items listed thereafter and equivalents thereof as well as and additional items.

Having described several embodiments of the techniques described herein in detail, various modifications, and improvements will readily occur to those skilled in the art. Such modifications and improvements are intended to be within the spirit and scope of the disclosure. Accordingly, the foregoing description is by way of example only, and is not intended as limiting. The techniques are limited only as defined by the following claims and the equivalents thereto.

1. A method for execution by a write interlock, comprising an act of:
performing first processing and second processing, decoupled from the first processing, wherein:
the first processing comprises acts of:
receiving, from a processor, a store instruction including a target address;
storing, in a data structure, a first entry corresponding to the store instruction, wherein the first entry includes information relating to the target address of the store instruction;
initiating a check of the store instruction against at least one policy; and
in response to successful completion of the check, removing the first entry from the data structure; and
the second processing comprises acts of:
receiving, from the processor, a write transaction including a target address to which data is to be written;
in response to receiving the write transaction, determining whether any entry in the data structure relates to the target address of the write transaction; and
in response to determining that no entry in the data structure relates to the target address of the write transaction, causing the data to be written to the target address of the write transaction.

2. The method of claim 1, wherein the second processing further comprises:
causing the write transaction to be stalled.

3. The method of claim 2, wherein:
the write transaction is stalled for a period of time; and
the period of time is selected based on an estimated amount of time between the processor executing the store instruction and the first entry corresponding to the store instruction being stored by the write interlock in the data structure in the first processing.

4. The method of claim 2, wherein:
the write transaction is stalled until a selected number of instructions has been received from the processor in the first processing.

5.-9. (canceled)

10. The method of claim 1, wherein:
the write transaction from the processor comprises a first write transaction, and is received by the write interlock on a first interface; and
in response to determining that no entry in the data structure relates to the target address of the write transaction, the data is written to the target address of the write transaction via a second write transaction on a second interface.

11. The method of claim 1, wherein:
the write transaction from the processor comprises a first write transaction, and is received by the write interlock on a first interface;
the second processing further comprises acts of:
storing the first write transaction in a write queue; and
acknowledging the first write transaction to the processor; and
in response to determining that no entry in the data structure relates to the target address of the write transaction, the data is written to the target address of the write transaction via a second write transaction on a second interface.

12. The method of claim 11, wherein:
the second processing further comprises an act of determining whether the target address of the write transaction is cached; and
the first write transaction is stored in the write queue in response to determining that the target address of the write transaction is not cached.

13. The method of claim 11, wherein:
the data written by the second write transaction is retrieved from an entry in the write queue storing the first write transaction; and
the second processing further comprises an act of:
after retrieving the data for the second write transaction, removing, from the write queue, the entry storing the first write transaction.

14. (canceled)

15. The method of claim 1, wherein:
the write interlock acknowledges the write transaction to the processor, but discards the data of the write transaction.

16. The method of claim 1, wherein:
the write transaction from the processor comprises a first write transaction, and is received by the write interlock on a first interface;
the second processing further comprises acts of:
determining whether the target address of the write transaction is cached; and
in response to determining that the target address of the write transaction is cached, causing the first write transaction to be stalled until it is determined that no entry in the data structure relates to the target address of the write transaction; and
in response to determining that no entry in the data structure relates to the target address of the write transaction, causing the data to be written to the target address of the write transaction via a second write transaction on a second interface.

17. The method of claim 16, wherein:
determining whether the target address of the write transaction is cached comprises determining whether the target address of the write transaction is included in an address range for non-cached addresses; and/or
determining whether a signal from a data cache indicates the target address of the write transaction as cached.

18. (canceled)

19. The method of claim 1, further comprising acts of:
performing a first destructive read instruction;
stalling a second destructive read instruction; and
in response to successful completion of a check of the first destructive read instruction, allowing the second destructive read instruction to proceed.

20. The method of claim 18, further comprising acts of:
capturing, in a buffer, data read from a target address of the destructive read instruction; and
in response to successful completion of the check of the destructive read instruction, discarding the data captured in the buffer.

21. The method of claim 20, further comprising an act of:
in response to unsuccessful completion of the check of the destructive read instruction, restoring the data captured in the buffer to the target address, and/or providing the data captured in the buffer to a subsequent instruction attempting to access the target address of the destructive read instruction.

22.-24. (canceled)

25. The method of claim 1, wherein:
the first entry corresponding to the store instruction further includes data to be stored to the target address of the store instruction;
the first processing further comprises an act of:
in response to successful completion of the check:
storing the data in a cache associated with the write interlock;
the second processing further comprises acts of:
receiving, from the processor, a read transaction including a target address from which data is to be read;
determining whether any entry in the data structure relates to the target address of the read transaction received from the processor; and
in response to determining that no entry in the data structure relates to the target address of the read transaction, causing the read transaction to access data in the cache associated with the write interlock.

26. The method of claim 25, wherein:
the read transaction is stalled until no entry in the data structure relates to the target address of the read transaction.

27. The method of claim 25, wherein the second processing further comprises an act of:
in response to determining that at least one entry in the data structure relates to the target address of the read transaction, causing the read transaction to access data from a most recent entry of the data structure related to the target address of the read transaction.

28. (canceled)

29. The method of claim 25, wherein:
the write interlock acknowledges a write transaction from the data cache of the processor, but discards data relating to the write transaction.

30. A system comprising:
at least one processor; and
at least one computer-readable medium having encoded thereon instructions which, when executed by the at least one processor, cause the at least one processor to perform first processing and second processing, decoupled from the first processing, wherein:
the first processing comprises acts of:
receiving, from a processor, a store instruction including a target address;
storing, in a data structure, a first entry corresponding to the store instruction, wherein the first entry includes information relating to the target address of the store instruction;
initiating a check of the store instruction against at least one policy; and
in response to successful completion of the check, removing the first entry from the data structure; and
the second processing comprises acts of:
receiving, from the processor, a write transaction including a target address to which data is to be written;
in response to receiving the write transaction, determining whether any entry in the data structure relates to the target address of the write transaction; and
in response to determining that no entry in the data structure relates to the target address of the write transaction, causing the data to be written to the target address of the write transaction.

31. At least one computer-readable medium having encoded thereon instructions which, when executed by the at least one processor, cause the at least one processor to:
perform first processing and second processing, decoupled from the first processing, wherein:
the first processing comprises acts of:
receiving, from a processor, a store instruction including a target address;
storing, in a data structure, a first entry corresponding to the store instruction, wherein the first entry includes information relating to the target address of the store instruction;
initiating a check of the store instruction against at least one policy; and
in response to successful completion of the check, removing the first entry from the data structure; and
the second processing comprises acts of:
receiving, from the processor, a write transaction including a target address to which data is to be written;
in response to receiving the write transaction, determining whether any entry in the data structure relates to the target address of the write transaction; and
in response to determining that no entry in the data structure relates to the target address of the write transaction, causing the data to be written to the target address of the write transaction.
